(19) United States
(12) Patent Application Publication
(10) Pub. No.: US 2025/0383488 A1
(43) Pub. Date: Dec. 18, 2025

(54) SYSTEM AND ASSOCIATED METHODS FOR A LIGHT FILTERING DEVICE

(71) Applicant: Sidus Space, Inc., Cape Canaveral, FL (US)

(72) Inventor: Valerij Ojdanic, Indian Harbour Beach, FL (US)

(73) Assignee: Sidus Space, Inc., Cape Canaveral, FL (US)

(21) Appl. No.: 18/742,400

(22) Filed: Jun. 13, 2024

(51) Int. Cl. G02B 5/20; B64G 1/10

(52) U.S. Cl. CPC G02B 5/201; B64G 1/1028

(57) ABSTRACT

A light filtering system for use in a light sensor carried by an orbital device is provided. The light filtering system may comprise a light filter device that may be removably carried by the light sensor. The light filter device may be positioned between a lens and one or more of a sub-sensor carried by the light sensor. The light filter device may be operable to receive light passed through the lens defined as captured light. The light filter device may also be operable to pass the captured light therethrough to filter one or more wavelengths of light from the captured light to define a filtered light. The at least one wavelength of light filtered out by the light filter device may comprise one or more wavelengths of light that may be inversely associated with an absorption band of a substance.

### FIELD OF THE INVENTION

The present invention relates to a light wavelength filtering device and associated methods thereof and, more specifically, to a light wavelength filtering device to be used in connection with sensors carried by orbital devices.

### BACKGROUND OF THE INVENTION

In the fields of space technology, the development of orbital devices such as satellites has been paramount in gathering data for various scientific, commercial, and security purposes. A critical components of some of these devices is a light sensor, which relies heavily on the accuracy and quality of light filtration to function optimally. The data that can be derived from the use of an effective light filter in a light sensor is widely sought after. There exists a significant need within the industry for a light filter that can further enhance and provide for the filtration performance that these sensors need. It can lead to breakthroughs in accurate climate monitoring, resource management, and even planetary exploration.

Historically, the prior art in light filtration for orbital devices has been fraught with limitations. The prior art have often been prohibitively expensive, limiting their accessibility to a broad customer base. Moreover, they have less than ideal reliability, succumb to the harsh conditions of space, such as extreme temperature fluctuations and radiation exposure. Additionally, the prior art have failed to provide for light filters that are easily configurable to filter desired wavelengths of light. The complexity and cost of development have deterred many potential users from attempting to create proprietary solutions, as the investment in time and resources required is substantial. The proposed light filter invention provides for light filter that overcomes the problems left unsolved by the prior art and provides for an improvement thereof, especially as related to the space industry.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a light filtering system for use in a light sensor carried by an orbital device, the orbital device may comprise an orbital computer including a processor, a network device, a power unit, and/or a datastore. The light filtering system may comprise a light filter device. The light filter device may be removably carried by the light sensor and may be positioned between a lens and one or more of a sub-sensor. The lens and the sub-sensor(s) may be carried by the light sensor.

The light filter device may be operable to receive light passed through the lens, which may be defined as captured light. The light filter device may also be operable to pass the captured light through the light filter device to filter one or more wavelengths of light from the captured light so that the light having the at least one wavelength of light filtered out may be defined as a filtered light. The at least one wavelength of light filtered out by the light filter device may comprise a wavelength of light that may be inversely associated with an absorption band of a substance.

The light filter device may also comprise one or more of a dielectric material liquid crystal filter, an acousto-optic tunable filter, a prism, and a diffraction grating system. The dielectric material may include one or more of a silicon dioxide, a color glass filter, a metal oxide, and a dye. In some embodiments, the light filtering device may also comprise a plurality of light filtering devices. Also, in some embodiments the light filtering device may further comprise a filter selection device that may be configured to select one of the plurality of light filtering devices which the captured light may be received by. In some embodiments, each of the plurality of light filter devices may be operable to filter out different wavelengths of light.

The filter selection device may be configured to carry the plurality of light filter devices. The filter selection may be operable to rotatably move relative to the light sensor to selectively position one of the plurality of light filter devices between the lens and the at least one sub-sensor to receive the captured light. In some embodiments, the system may further comprise a filter library which may be configured to be carried by the orbital device and may be configured to store the plurality light filter devices. The filter selection device may be configured to select one of the plurality of light filter devices from the filter library.

In some embodiments, each of the plurality of light filter devices may be positioned adjacent to one another to define a filter device pattern. Each light filter device of the filter device pattern may be configured to filter out a wavelength of light that may differ from adjacent light filter devices of the filter device pattern. The sub-sensor(s) may comprise a plurality of sub-sensors, and each light filter device of the filter device pattern may be associated with a respective sub-sensor of the plurality of sub-sensors.

In some embodiments, the plurality of filter devices may include a first filter device and a second filter device. The first filter device may be adapted to filter out a first wavelength of light, and the second filter device may be adapted to filter out a second wavelength of light. The filtered light may be defined as the captured light being passed through the first filter and the second filter. The one or more wavelengths of light filtered out by the light filter device may include wavelengths surrounding one or more of 440 to 520 nanometers (nm), 450 to 700 nm, 530 to 610 nm, 610 to 690 nm, and 740 to 900 nm filter ranges.

Some embodiments of the present invention may be related to a light filtering system for use in a light sensor carried by an orbital device. The light filtering system may comprise more than one filter device and a filter selection device. The light filter devices may be removably carried by the light sensor, and each of the light filter devices may be configured to receive light passed through a lens carried by the light sensor which may be defined as captured light. The filter selection device may be configured to carry each of the light filter devices and may be configured to select one of the light filtering devices which the captured light may be received by. The captured light may be passed through the selected light filter device to filter out one or more wavelengths of light from the captured light so that the light which has wavelength(s) of light filtered out may be defined as a filtered light. The one or more wavelengths of light filtered out may comprise a wavelength of light that may be inversely associated with an absorption band of a substance.

Some embodiments of the present invention may be related to a light filtering system for use in a light sensor carried by an orbital device. The light filtering system may comprise more than one light filter device, a filter selection device, and a filtered library. The plurality of light filter devices may be configured to receive light passed through a lens carried by the light sensor which may be defined as captured light. The filter selection device may be configured to select one of the light filtering devices that the captured light may be received by.

The filter library may be configured to store the plurality light filter devices. The captured light may be passed through the selected light filter device to filter out one or more wavelengths of light from the captured light so that the light that had wavelength(s) filtered out may be defined as a filtered light. Each of the light filter devices may be operable to filter out different wavelengths of light.

The one or more wavelengths of light filtered out may comprise a wavelength of light that may be inversely associated with an absorption band of a substance. The filter selection device may be operable to rotatably move relative to the light sensor to selectively position one of the light filter devices to receive the captured light. The filter selection device may be configured to select one of the plurality of light filter devices from the filter library.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic diagram illustratively showing an orbital device according to an embodiment of the present invention, and being utilized in connection with a sensor that may be carried by an orbital device.

FIG. 2 is an exploded perspective and schematic view of a light sensor and the orbital device illustrated in FIG. 1, and showing the filtering device being positionable between one or more sub-sensors and a lens that may be carried by the light sensor.

FIG. 3 is a schematic diagram illustrating the filtering device and light sensor illustrated in FIG. 1, and showing the lens receiving light reflected from the surface of the Earth.

FIG. 4 is a perspective and schematic view of a filter of the filtering device according to the present invention and showing the filtering device comprising a pattern of filter devices.

FIG. 5 is a schematic diagram of filter illustrated in FIG. 4 and showing light filtered by the filtering device illustrated in FIG. 1 and being sensed by a sub-sensor.

FIG. 6 is a graph showing quantum efficiency percentage versus wavelength(s) of light and showing ranges of light wavelengths filtered by one or more filters associated with the filtering device according to an embodiment of the present invention.

FIG. 7 is an illustration of exemplary light filter ranges of the filtering device according to embodiments of the present invention, as well as an exemplary pixel resolution of the light sensor.

FIG. 8 is a schematic diagram showing the filtering device illustrated in FIG. 1 and showing filtered light being received from consecutive moments of time as a series of frames that overlap one another relative to an area of the surface of the Earth.

FIG. 9 is a schematic diagram showing an embodiment of a filter selection device associated with the orbital device according to an embodiment of the present invention.

FIG. 10 is another schematic diagram showing an alternative embodiment of a filter selection device and a filter selection library associated with the orbital device according to an embodiment of the present invention.

FIGS. 11A-16 are flowchart illustrations of method aspects of the present invention.

FIG. 17 is a schematic diagram showing a plurality of orbital devices in communication with one another in a mesh network.

FIG. 18 is a schematic diagram illustratively showing an orbital device according to an embodiment of the present invention, and including a light sensor having multiple filtering devices positioned in series to consecutively filter light.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a light wavelength filtering device 101 that may receive one or more wavelengths of light and filter the one or more wavelengths of light received thereby. Throughout this specification, a person skilled in the art should note that the light wavelength filtering device 101 may be referred to as, for example and without limitation, a light wavelength filtering device 101, a light wavelength filter device 101, a light wavelength filter 101, a filtering device 101, a light filtering device 101, a filter device 101, a light filter device 101, or a device 101 and/or in any combination or combinations thereof and interchangeably. For the purposes of the description of the present invention, the term “light filtering system” may be used, without limitation, to refer to the light filter device 101, one or more embodiments of the light filter device 101, the various features of and/or features related to/associated with embodiments of the light filter device 101, and/or embodiments of the present invention that may include more than one light filtering device 101.

Those skilled in the art will appreciate that any of the above references is meant to include the present invention as will be described in greater detail hereinbelow. The light filter device 101 may be advantageously utilized to filter light received by the light filter device 101. The light filter device 101 may receive light that may be directed from a portion of the surface of the Earth 140, and the light filter device 101 may selectively filter/allow one or more wavelengths of the received light to pass through the light filter device 101.

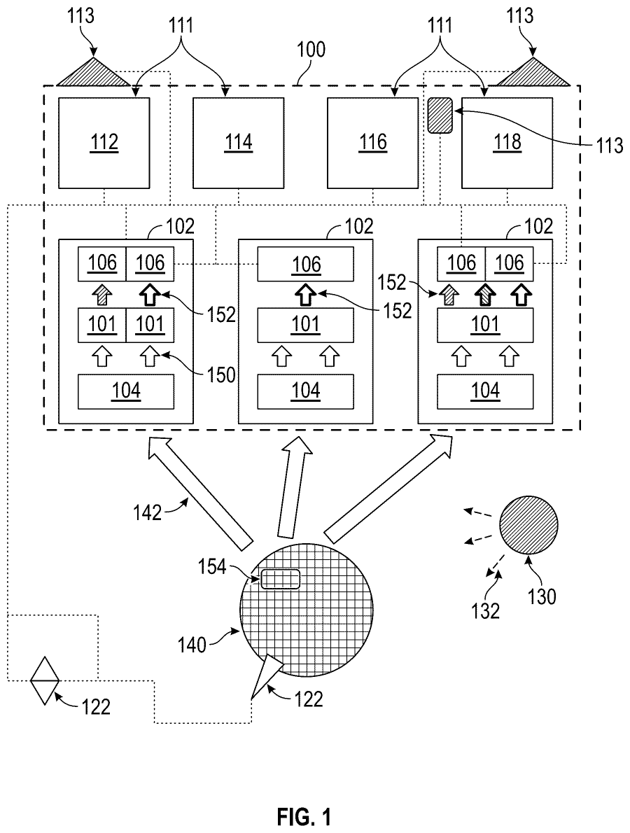

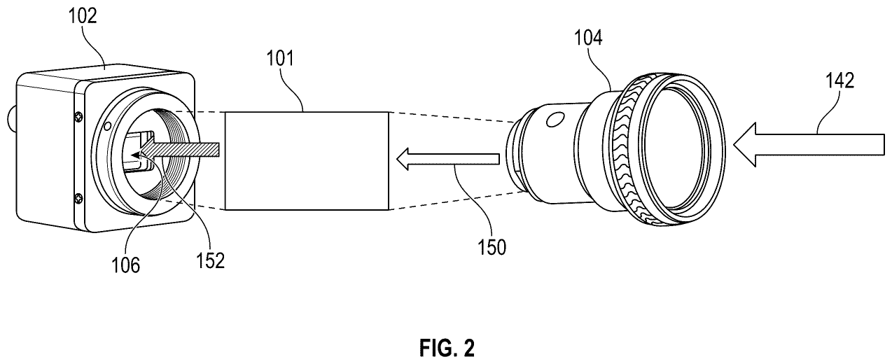

Initially referring to FIG. 1-3, the light filter device 101 may be adapted to be used in connection with a light sensor 102. The light sensor 102 that is illustrated in the appended drawings is a camera, but those skilled in the art will appreciate that the light sensor 102 may be provided by any other device suitable for sensing various wavelengths of light. Examples of the light sensor 102 include, without limitation, a device for sensing light that comprises one or more of spectrophotometer, photodiode array (PDA), spectrometer, prism and diffraction grating, interferometer, fluorescence spectrometer, monochromator, Fourier transform infrared spectrometer, colorimeter, and/or a radiometer and any combination or combinations thereof. Additionally, the light sensor 102 may include one or more of a housing, mounting components, a communication unit, a shutter, a processor, a data storage, a power unit, a photosensitive member, a communication interface, and any combination or combinations thereof as may be understood by those who may have skill in the art.

The light filter device 101 may be adapted to be removably carried by the light sensor 102. The light filter device 101 may be configured to be positioned between a lens 104, that may be carried by the light sensor 102, and one or more sub-sensor(s) 106, that may also be carried by the light sensor 102. In exemplary embodiments of the present invention, the light filter device 101 and/or the light sensor 102 may be adapted to be carried by an orbital device 100.

The orbital device 100 may be configured to be at least temporarily suspended in space outside of one of the atmospheres of Earth 140 and/or any other planet any may be understood by those who may have skill in the art, and/or the orbital device 100 may be configured to be at least temporarily suspended in space orbiting the Earth 140 and/or any other planet as may be understood by those who may have skill in the art. The orbital device 100 may also be configured to be at least temporarily suspended within one of the atmospheres of Earth 140 and/or of any other planet as may be understood by those who may have skill in the art, and/or the orbital device 100 may be configured to be at least temporarily suspended orbiting the Earth 140 within one of the atmospheres of Earth 140 and/or of any other planet as may be understood by those who may have skill in the art. For the purposes of the present invention, the term Earth 140 and/or atmosphere(s) of Earth 140 may also, without any limitation, refer to any other planet, moon, celestial body and/or any atmosphere(s) thereof as may be understood by those who may be skilled in the art, such as, and without limitation, the moon, Mars, Jupiter, Venus, Mercury, Saturn, Neptune, Uranus, Pluto, asteroids, asteroid belts, and/or other moons.

In a preferred embodiment of the present invention, the orbital device 100 is provided by a satellite, and the light sensor 102 may be carried by an interior portion of the satellite. In such an embodiment, the satellite may include outer doors that may be moved between a closed position and an open position. The closed position of the outer doors may be one in which the light sensor 102 is carried fully within the satellite and is not exposed to an area outside the satellite. The open position of the outer doors may be one in which the light sensor 102 is exposed to an area outside the satellite, but it still carried by an interior portion of the satellite. As indicated above, the light sensor 102 may be provided by a camera. It is contemplated that the satellite may travel in an orbital path about the Earth 140. As the satellite is traveling in the orbital path, the camera or light sensor 102 is positioned to collect data from the Earth 140. It is also contemplated that the satellite may be adapted to change orientation to allow for different perspectives of the light sensor 102. It is also contemplated that the satellite may be adapted to be moved to alternate orbit paths about the Earth 140 to allow for the light sensor 102 to collect alternative data.

In an exemplary embodiment of the present invention, the light filter device 101 may be carried by a light sensor 102 that is housed by an orbital device 100 comprising modular satellite comprising one or more components that are made by three-dimensional fused filament fabrication using onyx infused filament. For example, the orbital device 100 may be provided by an embodiment of the modular satellite platform described in U.S. patent application Ser. No. 17/828,233 filed on May 31, 2022, and titled SYSTEM FOR A MODULAR SATELLITE TESTING PLATFORM (attorney docket no. 6270.00019), of which the entire contents therein is incorporated herein by reference, except for where the content therein conflicts with the content herein. Similarly to some of the embodiments of the orbital device 100 described above, some embodiments of the light filter device 101 may be configured and adapted to withstand, have resistance to, and/or be functional while in, the presence of an environment of space and/or of the atmospheres of the Earth 140. The filter device(s) 101 may comprise one or more of, without limitation, dielectric material such as silicon dioxide, color glass filter, metal oxide, and/or dye, a liquid crystal filter, an acousto-optic tunable filter, a prism, and/or a diffraction grating system and any combinations thereof as may be understood by those who may have skill in the art.

As mentioned above, and moreover, some embodiments of the orbital device 100, the light filter device 101, the light sensor 102, and/or any one or more of the other components described herein may be adapted to survive in, operable while exposed to, and/or be configured to be substantially unaffected by, exposure to the environment of space/outer space, an orbit of Earth 140, and/or the vacuum of space, for a predetermined period of time. The orbital device 100 may be configured to orbit the Earth 140 within and/or outside of an atmosphere of Earth 140. More examples of the orbital device 100 include, without limitation, a satellite, a shuttle, a rocket, a high altitude aerial device, and any combinations thereof and any other device that may be utilized for high altitude or orbital photography as the orbital device 100.

The orbital device 100 may carry one or more of an orbital computer 111. The orbital computer 111 may include, for example, one or more of a processor 112, a datastore 114, a network device 116, and a power unit 118 as each may be understood by those who may have skill in the art. Also, the orbital computer 111 may include one or more other components as may be understood by those who may have skill in the art. For example, without limitation, the orbital computer 111 may also include one or more of a co-processor, a memory unit, a graphics processing unit, a chassis/housing, an input-output port, a cooling system, a sound processor, a network interface card, an expansion slot, an expansion card, an input-output device, a user interface, a graphical user interface, a display, a non-volatile computer-readable memory, a volatile computer-readable memory, and/or any combination or combinations thereof. For increased terseness and for the purposes of the description of the present invention, the orbital computer 111 and orbital computers 111 may refer to the processor 112, the datastore 114, the network device 116, and/or the power unit 118 individually, in the entirety, and in any combinations thereof without any limitation intended or implied thereby. In an exemplary embodiment of the present invention, the orbital computer 111 may at least comprise a portion of the components, members, and/or units described in U.S. patent application Ser. No. 18/175,977 filed Feb. 28, 2023 and titled HOST SATELLITE HAVING PRIORITIZED ANALYTICS ASSOCIATED WITH DETECTED OBJECTS AND MISSION CONSTRAINTS FOR COMMUNICATION WITH CLIENT TERMINAL (attorney docket no. 6270.00055), of which the entire contents therein is incorporated herein by reference except for where the content therein conflicts with the content herein.

The orbital computer 111 and/or processor 112 may utilized to receive, send, compute, analyze, read, write, and/or execute computer-readable data, code, signals, information, instructions, and/or executables. Examples of the processor 112 include, without limitation, a central processing unit, a field-programmable gate array, a microprocessor, a microcontroller, a graphics processing unit, a non-volatile computer-readable memory, a volatile computer-readable memory, and any combinations thereof. The datastore 114 may be utilized to read, write, receive, send, and/or store computer-readable data, code, signals, information, instructions, and/or executables. Examples of the datastore 114 include, without limitation, a hard drive, a solid state drive, a disk drive, a compact-disc, a floppy disk, magnetic tape, nonvolatile computer-readable memory, volatile computer-readable memory, and any combinations thereof.

The network device 116 may be utilized to read, write, convert, interpret, transmit, receive, transceive, send, detect, sense, and/or facilitate communication of computer-readable data, code, signals, information, instructions, and/or executables. Examples of the network device 116 include, without limitation, a network card, a router, a modem, a hub unit, an antenna, a satellite dish, a transceiver, and any combinations thereof. The power unit 118 may be utilized to provide, manage, monitor, generate, facilitate, store, and/or send electrical power to electronic components that the power unit 118 may be in communication with. Examples of the power unit 118 include, without limitation, a power storage device, a power generation device, a power management device, a battery, a photovoltaic device, a transformer, a rectifier, an inverter, a voltage regulator, an amperage regulator, a power signal generator, and any combinations thereof.

In some embodiments of the present invention, the orbital device 100 may be configured to carry one or more of the light sensors 102 therein, and the filter device(s) 101 may be carried by one of the light sensors 102. The orbital device 100 may be positioned in space and/or adapted to orbit the Earth 140, and the orbital device 100 may be oriented relative to Earth 140 such that light may be receivable from at least a portion of the Earth 140 by the orbital device 100, the one or more sensors 102, and/or the lens(es) 104 of the one or more sensors 102. The light received by the orbital device 100, the one or more sensors 102, and/or the lens(es) 104 may comprise sunlight 132 that may have been reflected by the Earth 140 and from the Sun 130 towards the orbital device 100, towards the one or more sensors 102, and/or towards the lens(es) 104, which may be defined herein as, and referred to herein as, reflected light 142. The reflected light 142 may be received by the light sensors 102 and/or lens(es) 104, which may be defined herein, and referred to herein, as captured light 150. The captured light 150 by the light sensors 102 and/or lens(es) 104 may comprise reflected light 142 received from one or more portions of the surface of the Earth 140. The captured light 150 by the light sensors 102 and/or lens(es) 104 may also comprise reflected light 142 received from one or more areas of the Earth 140.

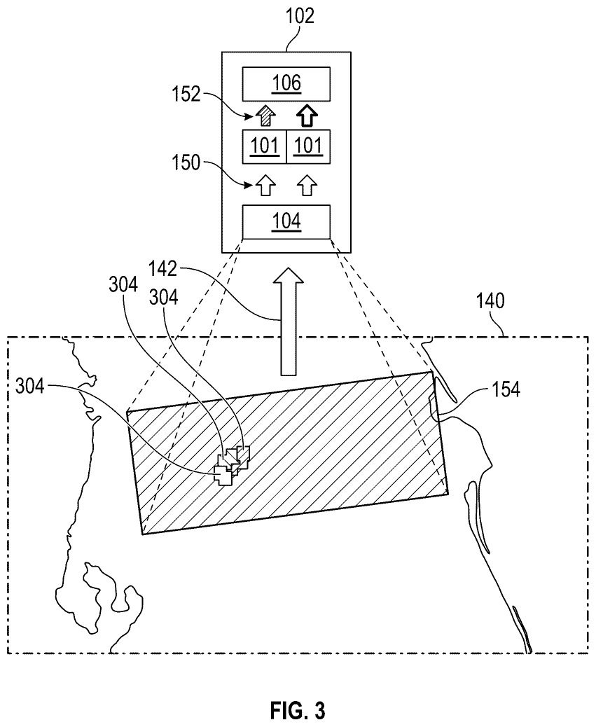

The orbital device 100 and/or sensors 102 carried by the orbital device 100 may be orientable in orbit such that the orbital device 100, sensors 102, and/or lens(es) 104 may be positioned to receive reflected light 142 from either, or both, a predetermined portion of the surface of the Earth 140 and from a predetermined area of the Earth 140. The predetermined portion of the Earth 140 and/or the predetermined area of the Earth 140 may be defined as a target area 154 of the Earth 140, which may be best illustratively shown in FIG. 3. The orbital device 100 may include orientation components 113 that may be selectively controlled and/or activated to change and/or maintain the orientation and/or orbit of the orbital device 100. For example, without limitation, the orientation components 113 may comprise one or more of thrusters, boosters, gyroscopes, global positioning systems, and any combinations thereof. The reflected light 142 received from the target area 154 by the light sensors 102 and/or lens(es) 104 may be received, and/or selectively received, by the lens(es) 104. The lens(es) 104 may allow for the reflected light 142 received by the lens(es) 104 to pass through, refracted through, travel through, be focused through, and/or optically directed through the lens(es) 104 to define captured light 150. The lens(es) 104 may send, pass, refract, focus, and/or optically direct the captured light 150 to and/or towards one or more of filter devices 101.

The light filter device 101 may receive the captured light 150 from the lens(es) 104. The light filter device 101 may be configured to filter and/or convert one or more portions and/or wavelengths of the captured light 150 received thereby, and/or the light filter device 101 may be configured to allow one or more portions and/or wavelengths of the captured light 150 to pass through the light filter device 101 substantially unchanged as may be understood by those who may have skill in the art. Captured light 150 received by, filtered by, converted by, and/or allowed through, the light filter device 101 may define filtered light 152. The light filter device 101 may be configured to send, pass, refract, focus, and/or optically direct and/or allow the filtered light 152 to travel from the light filter device 101 to and/or towards one or more sub-sensor(s) 106.

The sub-sensor(s) 106 may be configured to receive filtered light 152 from the filter device(s) 101. The sub-sensor(s) 106 may be configured to sense, detect, and/or determine the wavelength(s) of light and/or wavelength range(s) of light of the filtered light 152 received thereby. The sub-sensor(s) 106 may be configured to generate and/or emit sensed light data related to the wavelength(s) and/or wavelength range(s) of light of the filtered 152 light received and detected by the sub-sensor(s) 106. For example, and without limitation, the sub-sensor(s) 106 may be configured to receive the filtered light 152 and sense, detect, and/or determine the wavelength(s) and/or wavelength range(s) of light with respect to the filtered light 152 received including, without limitation, wavelength(s) and/or wavelength range(s) of one or more of visible light band(s), infrared light band(s), microwave band(s), radio wave band(s), ultraviolet light band(s), x-ray band(s), gamma ray band(s), and/or any combination or combinations thereof. However, it is contemplated that the sub-sensor(s) 106 may be configured to sense, detect, and/or determine the wavelength(s) and/or wavelength range(s) of light of any light that may be received by the sub-sensor(s) 106 including filtered light 152, captured light 150, reflected light 142, sunlight 132, and any other light as may be understood by those who may be skilled in the art. Examples of the sub-sensor(s) 106 include, without limitation, photodiodes, photomultiplier tubes, charge-coupled devices, CMOS image sensors, phototransistors, avalanche photodiodes, fiber optic sensors, photonic integrated circuits, optical filters, and/or prisms and diffraction gratings and any combination or combinations thereof.

The sub-sensor(s) 106 and/or light sensor(s) 102 may be in communication with the orbital computer 111. For example, without limitation, the sub-sensor(s) 106 and/or light sensor(s) 102 may be in communication with the processor 112, the datastore 114, and/or the network device 116. In some embodiments, the sub-sensor(s) 106 may be in communication with one another, and/or the sub-sensor(s) 106 may be in communication with one or more of the light sensor(s) 102. The sub-sensor(s) 106 and/or light sensor(s) 102 may be configured to emit and send the sensed light data to one or more of the orbital computer 111. The orbital computer 111 and/or the processor 112 may receive the sensed light data and transmit the sensed light data to one or more communication stations 122 that the orbital computer 111 and/or the processor 112 and/or network device 116 may be in communication with. The orbital computer 111 and/or the processor 112 may also store the sensed light data in the datastore 114. The communication stations 133 may include one or more of, without limitation, a satellite, a datacenter, a ground station, a telecommunication device, a communication dish and/or antenna, and any combinations thereof.

In some embodiments of the present invention, the orbital computer 111 and/or the processor 112 may be configured to interpret, process, compute, read, and/or analyze the sensed light data received and the orbital computer 111 and/or the processor 112 may determine and/or identify if there is one or more of a target event 304 present in the target area 154 of Earth 140. In some embodiments of the present invention, upon the orbital computer 111 and/or the processor 112 determining that one or more target event(s) 304 are present in the sensed light data, the orbital computer 111 and/or the processor 112 may associate the determined target event(s) 304 with the sensed light data to define target event data. The orbital computer 111 and/or the processor 112 may be operable store the target event data in the datastore 114. The orbital computer 111 and/or the processor 112 and/or the datastore 114 may be operable to allow the orbital computer 111 and/or the processor 112 to access and receive target event data stored in the datastore 114. The orbital computer 111 and/or the processor 112 may also be operable to send and/or transmit the target event data to a communication station 122.

The orbital computer 111 and/or the processor 112 may interpret, process, compute, read, and/or analyze the sensed light data received and the orbital computer 111 and/or the processor 112 to determine if a target event 304 is present in the sensed light data by determining if one or more target event criteria wavelength(s) are present in the sensed light data. The target event criteria wavelengths may be associated with an absorption band of a material, element, substance, composition of matter, mixture, and/or object. For example, without limitation, a target event criteria wavelength may comprise a wavelength within a range of about 1635 nanometers to about 1685 nanometers, which may be associated with the absorption band of methane, and thus may indicate that methane may be present within the target area 154 of Earth 140 from which reflected light 142 has been received by the lens(es) 104.

In some embodiments of the present invention, the orbital computer 111 and/or the processor 112 may also/instead send the sensed light data to one or more of the receiving stations 122. The receiving station(s) 122 may interpret, process, compute, read, and/or analyze the sensed light data received thereby to determine if a target event 304 is present in the sensed light data by determining if one or more target event criteria wavelength(s) are present in the sensed light data.

In some embodiments of the present invention, it is preferable that the orbital computer 111 and/or the processor 112 of the orbital device 100 processes the sensed light data to determine if target event(s) 304 may be present in the target area 154, rather than/instead of the orbital computer 111 and/or the processor 112 sending/transmitting the sensed light data to a communication station 122 to be processed thereby to determine if target event(s) 304 may be present in the target area 154. Those who may have skill in the art may notice and appreciate that in these preferred embodiments, the computational power of the communication station(s) 122 will thus advantageously enjoy a reduced demand for processing all the sensed light data from the orbital device 100 and/or from multiple orbital devices 100 in comparison to the prior art limited to transmitting all the captured data from a satellite to a ground station for processing. Moreover, in these preferred embodiments, network bandwidth is greatly reduced by not requiring the orbital device(s) 100 to send all the sensed light data to the communication station(s) 122 for processing to identify possible target event(s) 304 in target area(s) 154.

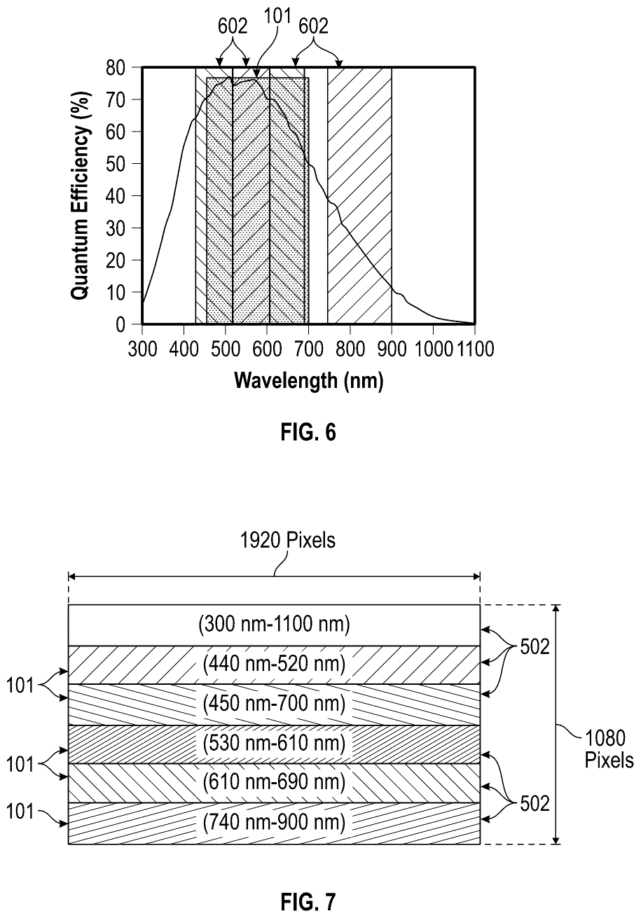

Now referring to FIGS. 1, and 3-8, the filter device(s) 101 may be configured to filter out predetermined wavelength(s) of light and/or filter out predetermined range(s) of wavelengths of light from the captured light 152 received thereby. For increased terseness and for the purposes of the description of the present invention, the terms “predetermined wavelength(s) of light,” “predetermined range(s) of wavelengths of light,” “predetermined wavelength(s),” and “predetermined ranges of wavelength(s),” and any grammatical forms thereof, may be used interchangeably without any limitation intended or implied thereby. The predetermined wavelength(s) of light filtered out by an embodiment of the filter device(s) 101 may comprise wavelengths of light that are not within, different from, and/or dissimilar to one or more of a predetermined filter range 502 (which, which limitation, may be interchangeably referred to as “filter range(s) 502”). Thus, in contrast, the resulting filtered light 152 from the captured light 150 filtered by the filter device(s) 101 may comprise wavelength(s) of light that are within, similar to, and/or about the same as one or more predetermined filter range(s) 502/filter range(s) 502.

For example, and without limitation, to form the filtered light 152, the predetermined wavelength(s) filtered out from the captured light 150 by the filter device(s) 101 may comprise wavelength(s) of light outside of, different from, and/or dissimilar to filter range(s) 502 that may comprise one or more of 440 to 520 nanometers (blue light), 450 to 700 nanometers (pan light), 530 to 610 nanometers (green light), 610 to 690 nanometers (red light), and/or 740 to 900 nanometers (near-infrared light) and any combination or combinations thereof. Thus, the filter device(s) 101 may allow wavelength(s) of the captured light 152 within, similar to, and/or about the same as the filter range(s) 502 to pass through the light filter device 101 and/or to be directed towards/to be received by the one or more sub-sensor(s) 106 as the filtered light 152.

Therefore, the predetermined wavelength(s) filtered out from the captured light 150 by the filter device(s) 101 to form the filtered light 152 by filtering out wavelength(s) of light outside of one or more filter range(s) 502, such that the predetermined wavelength(s) may be referred to as being inversely associated with the one or more filter range(s) 502. For the purposes of the present invention, it should be understood that the term “inversely associated” means that the filtered out predetermined wavelength(s) in relation to one or more filter ranges 502 comprises one or more of all wavelength(s) that are all not within the filter range(s) 502, wavelength(s) with the majority being not within the filter range(s) 502, and/or wavelength(s) substantially surrounding the filter range(s) 502. Also, for the purposes of the present invention, it should be understood that the predetermined wavelength(s) filtered out from the captured light 150 by the filter device(s) 101 may alternatively be referred to as the filter range(s) 502 of the filter device(s) 101, without any limitation.

Also, it is known and understood that the filter device(s) 101 may be configured to filter out and allow any wavelength(s) and/or range(s) of light of the captured light 152 received by the light filter device 101 including any wavelength and/or any range of the visible light band(s), infrared light band(s), microwave band(s), radio wave band(s), ultraviolet light band(s), x-ray band(s), gamma ray band(s), and any combinations thereof.

The filtered out predetermined wavelength(s) outside of the filter range(s) 502 may comprise wavelength(s) of light that may not associated with wavelength(s) of reflected light 142 which are related to one or more target events 304. More specifically, the filter device(s) 101 may be configured to allow one or more predetermined wavelength(s) within the filter range(s) 502 of the captured light 150 to pass through the light filter device 101 unchanged as filtered light 152, with the resulting filtered light 152 then comprising wavelength(s) of light that may be associated with one or more target event(s) 304. For the purposes of the present invention, the predetermined wavelength(s) of light being allowed to pass through the light filter device 101 unchanged is understood mean that the wavelength(s) of the captured light 150 travel through the filter device(s) 101 with their wavelength(s) substantially unchanged, and defined as filtered light 152.

For example, without limitation, the wavelength(s) not filtered out from the captured light 152 and/or the filter range(s) 502 not filtered out from the captured light 152 may include one or more wavelength(s) inversely related to/inversely associated with the light wavelength absorption band(s) of one or more of an element, composition, substance, chemical, gas, and any combinations thereof. For example, and without limitation, the predetermined wavelength(s) and/or filter range(s) 502 not filtered out from the captured light 152 may include one or more wavelength(s) correlated to the light wavelength absorption band(s) of one or more of water and water vapor (around 0.94 micrometers, 1.13 micrometers, and 1.38 micrometers), carbon dioxide (around 2 micrometers, and 4.3 micrometers), ozone (lower than about 0.3 micrometers), methane (between about 1.65 micrometers and 2.3 micrometers), carbon monoxide (around 4.6 micrometers) nitrous oxide (around 4.5 micrometers), sulfur dioxide (around 7.3 micrometers), ammonia (around 23.8 micrometers), oxygen (lower than about 0.24 micrometers), and chlorophyll (around about 0.665 micrometers to 0.68 micrometers, about 0.43 micrometers to 0.45 micrometers, about 0.64 micrometers to 0.66 micrometers, and about 0.45 micrometers to 0.47 micrometers), and any combinations thereof.

As may be understood by those who may have skill in the art, the absorption band of a substance is the band/range of wavelength(s) of light that the substance absorbs, such that a substantial portion of the wavelength(s) within the substance's absorption band will not pass through that substance and/or be detectable from light passing through and/or traveling from that substance. Therefore, by detecting which bands of light are least present, and/or that are not present, within reflected light 142 from a target area 154, a target event 304 may be identified thereby with the orbital computer 111 and/or the processor 112 and/or the communication station(s) 122 based on the sensed light data emitted from the sub-sensor(s) 106. Specifically, by determining which wavelength(s) of light of the sensed light data are abnormally low in comparison to a predetermined wavelength presence with the orbital computer 111 and/or the processor 112 and/or the communication station(s) 122, one or more target event(s) 304 may be identified and indicative of the presence of a substance, material, composition, and/or element within the target area 154 having an absorption band associated with that/those wavelength(s) of light abnormally low within the sensed light data.

According to an exemplary embodiment of the present invention, the filter device(s) 101 may be configured to filter out wavelength(s) of light from the captured light 150 received that are outside the absorption band wavelength(s) of water vapor, carbon dioxide, methane, and/or chlorophyll such that, the sub-sensor(s) 106 may be restricted to sensing the presence, and/or absence, of the wavelength(s) within the absorption band(s) of those substance(s) upon receiving the filtered light 152 from the filter device(s) 101. The sub-sensor(s) 106 may send the sensed light data to the orbital computer 111 and/or the processor 112 and/or communication station(s) 122 that may then determine if target event(s) 304 relating to, and indicative of, water vapor, carbon dioxide, methane, and/or chlorophyll is/are present within the target area 154 based on the sensed light data.

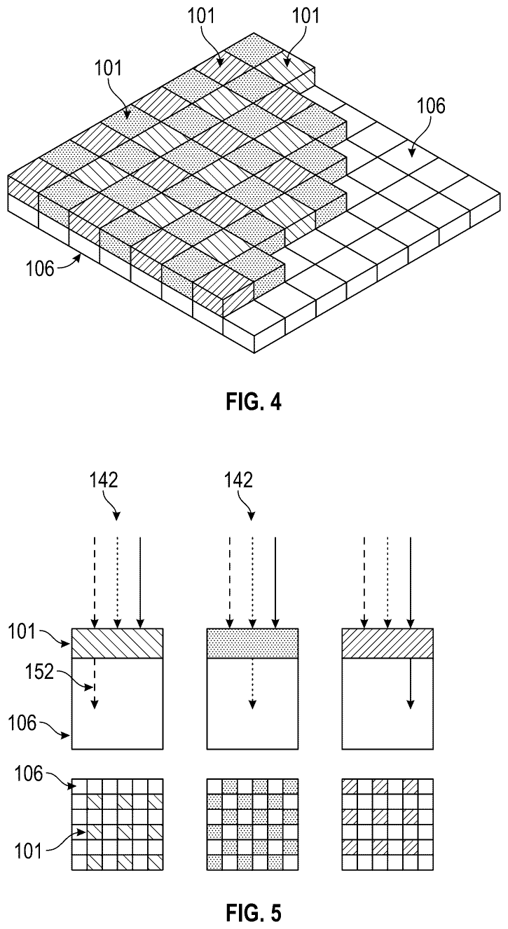

Now referring to FIGS. 1 and 4, some embodiments of the light filtering system and/or the light filter device 101 may comprise a filter device 101 pattern, which perhaps is best illustratively shown in FIG. 4. The light filter device 101 pattern may comprise a plurality of filter devices that may be positioned adjacent to and/or in close proximity with one another. Each filter device 101 of the light filter device 101 pattern may have filter range(s) 502 that may be the same, similar to, different than, and/or differ from the filter range(s) 502 of the other filter devices 101 of the light filter device 101 pattern. The light filter device 101 pattern may comprise a plurality of filter devices 101 in an organized and/or a disorganized pattern. For example, and without limitation, the filter devices 101 of the light filter device 101 pattern may be arranged in a pattern such that filter devices 101 with the same and/or similar filter range(s) 502 are not adjacent to one another, and such that each filter device 101 is positioned adjacent to other filter devices 101 of the light filter device 101 pattern that have different filter range(s) 502.

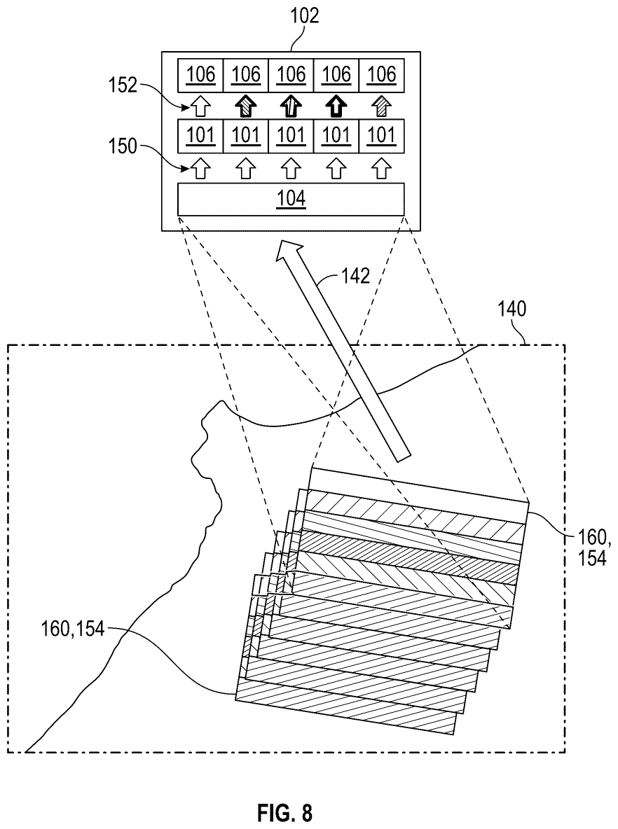

Now referring to FIGS. 7-8, some embodiments of the present invention may include multiple filter devices 101 stacked on one another in a sort of layered arrangement, which may form, and may be referred to herein as, a layering of filter devices 101. The layering of filter devices 101 is perhaps best illustratively shown in FIG. 7. The layering of filter devices 101 may each receive captured light 142 from the lens(es) 104. Each filter device 101 of the layering of filter devices 101 may filter range(s) 502 different from the other filter devices 101 of the layering of filter devices 101. For example, without limitation, each filter device 101 of the layering of filter devices 101 may be configured to filter captured light 142 to allow light to pass through the light filter device 101 which is within one or more filter range(s) 502 comprising 440 to 520 nanometers (blue light), 450 to 700 nanometers (pan light), 530 to 610 nanometers (green light), 610 to 690 nanometers (red light), or 740 to 900 nanometers (near-infrared light).

In some embodiments of the present invention that comprise more than one filter device 101, including filter devices 101 of a filter device 101 pattern and/or filter devices 101 of a layering of filter devices 101, each filter device 101 may be associated with a respective sub-sensor 106 to which the light filter device 101 may allow and/or directed filtered light 152 thereto. In other embodiments of the present invention, each filter device 101 may allow and/or direct filtered light 152 to a single sub-sensor 106 that may be shared with one or more other filter devices 101. The single sub-sensor 106 may be configured to sense and/or detect multiple wavelengths of light within multiple filter range(s) 502 of the filtered light 152 received by the sub-sensor 106.

Some embodiments of the present invention may include a single filter device 101 that may be configured to direct filtered light 152 therefrom to a plurality of sub-sensors 106. For example, without limitation, the light filter device 101 may be configured to act as a light wavelength filter and may also split the wavelength(s) of light of captured light 150 received by the light filter device 101 into a respective number of filter lights 152 by wavelength, with each being directed to a respective sub-sensor 106. Another example, and without limitation, the light filter device 101 may receive captured light 150 that may include one or more wavelengths within the absorption band(s) of one or more elements, compositions, substances, chemicals, gases, and any combinations thereof. The light filter device 101 may be configured to filter out wavelength(s) of light that are not included in one or more of the absorption band(s), and the light filter device 101 may direct each of the filtered light 152 wavelength(s) based on their associated absorption band(s) towards a respective sub-sensor 106. Each respective sub-sensor 106 may be associated with the filter range and/or absorption band of the filtered light 152 directed towards the sub-sensor 106.

Now referring more specifically to FIG. 7, in some embodiments of the present invention, one or more filter device(s) 101 may be sized and/or configured to filter captured light 150 and/or direct filtered light 152 in a dimension that may be equivalent to a resolution size and/or pixel size of a light sensor 102 and/or sub-sensor(s) 106 of a light sensor 102. For example, without limitation, the filter device(s) 101 and/or filter device 101 pattern may be sized and/or configured to filter captured light 150 and/or direct filtered light 152 in a dimension that may be equivalent to a resolution size and/or pixel size of a light sensor 102 and/or sub-sensor(s) 106 of a light sensor 102 that may comprise about 1920 pixels by 1080 pixels. However, it is contemplated and understood that filter device(s) 101 and/or filter device 101 pattern(s) may be sized and/or configured to filter captured light 150 and/or direct filtered light 152 in a dimension that may be equivalent to any resolution size and/or pixel size.

In some embodiments of the present invention, the light sensor 102 and/or lens 104 may be configured to selectively allow reflected light 142 to be received and/or captured by the lens 104 during one or more moments of time, which may be defined as taking a frame. In some embodiments of the present invention, the light sensor 102 and/or lens 104 may be configured to selectively and/or consecutively and successively allow, reflected light 142 to be received and/or captured by the lens 104 as captured light 150 for one or more moments of time, which may be referred to as a performing a frame rate and/or taking a series of frames 160. Each frame may be related to the reflected light 142 from the particular portion, area, and/or target area 154 of the Earth 140 captured by the lens(es) 104 as captured light 150 at a particular instance of time. The orbital computer 111 and/or the processor 112 may associate each frame with its related reflected light 142, the geolocation of the related reflected light 142, the time stamp of the related reflected light 142, and the sensed light data generated by the sub-sensor(s) 106 from the filtered light 152 that resulted from the captured light 150 and/or the reflected light 142 received from an area and/or target area 154 of the surface of the Earth 140. The orbital computer 111 and/or the processor 112 may also associate each frame with one or more target event(s) 304 that are determined by the orbital computer 111 and/or the processor 112 to be present in the resulting sensed light data of the frame.

The light sensor 102 and/or lens 104 may be selectively controlled by the orbital computer 111 and/or the processor 112 to take a frame and/or take a series of frames 160 upon the orbital computer 111 and/or the processor 112 determining that the orbital device 100, light sensor 102, and/or lens 104 is oriented towards a target area 154 of the Earth 140. In some embodiments of the present invention, the processor 112 may be configured to selectively control the light sensor 102 and/or the lens 104 to take a frame and/or take a series of frames 160 based on a mission instruction that may be related to one or more target area(s) 154. The orbital computer 111 and/or the processor 112 may be configured to selectively control the light sensor 102 and/or the lens 104 to take a frame and/or take a series of frames 160 upon the orbital computer 111 and/or the processor 112 determining that the orbital device 100, light sensor 102, and/or lens 104 is/are oriented towards a target area 154 related to the mission instruction. The mission instruction may be received by the orbital computer 111 and/or the processor 112 from a communication station 122, and/or the mission instruction may be generated by the orbital computer 111 and/or the processor 112 based on mission data stored in the datastore 114. More details on the orbital computer 111 and/or the processor 112 and the mission instruction follows further below.

In some embodiments of the present invention, the light sensor 102 and/or lens 104 may be selectively controlled by the orbital computer 111 and/or the processor 112 to take a series of frames 160 upon the orbital computer 111 and/or the processor 112 determining that the orbital device 100, light sensor 102, and/or lens 104 is oriented towards a plurality of target areas 154 of the Earth 140 which may at least partially overlap with one another, with each frame of the series of frames 160 being associated with one target area 154 of the plurality of target areas 154. The orbital computer 111 and/or the processor 112 and/or a communication station 122 may determine if a target event 304 is present in one or more of the plurality of target areas 154 based on the resulting series of sensed light data received via the series of frames 160.

In some embodiments of the present invention, the light sensor 102 and/or lens 104 may be selectively controlled by the orbital computer 111 and/or the processor 112 to take a series of frames 160 and/or perform a frame rate, based on a ground speed of the orbital device 100 relative to the surface of Earth 140 and based on the view swath of the lens 104 and/or the view swath of the filter device(s) 101. For example, without limitation, the orbital computer 111 and/or the processor 112 may determine and/or receive ground speed data related to the ground speed of the orbital device 100 relative to the surface of the Earth 140 and selectively control the light sensor 102 and/or lens 104 to take a series of frames 160 and/or to perform a frame rate to receive reflected light 142 (and thus capture light 150) such that the view swath of the lens 104 and/or the view swath of the filter device(s) 101 at least partially overlap with one another between each frame of the series of frames 160. The frames 160 of the series of frames 160 may overlap with one another such that, in embodiments of the present invention that include multiple filter devices 101 as a pattern of filter devices 101 and/or a layering of filter devices 101, the frames 160 of the series of the frames 160 may include a filtered light 152 (and thus sensed light data) from each of the multiple filter devices 101 related to the same portion and/or area of the surface of Earth 140. Which is perhaps as best illustratively shown in FIG. 8.

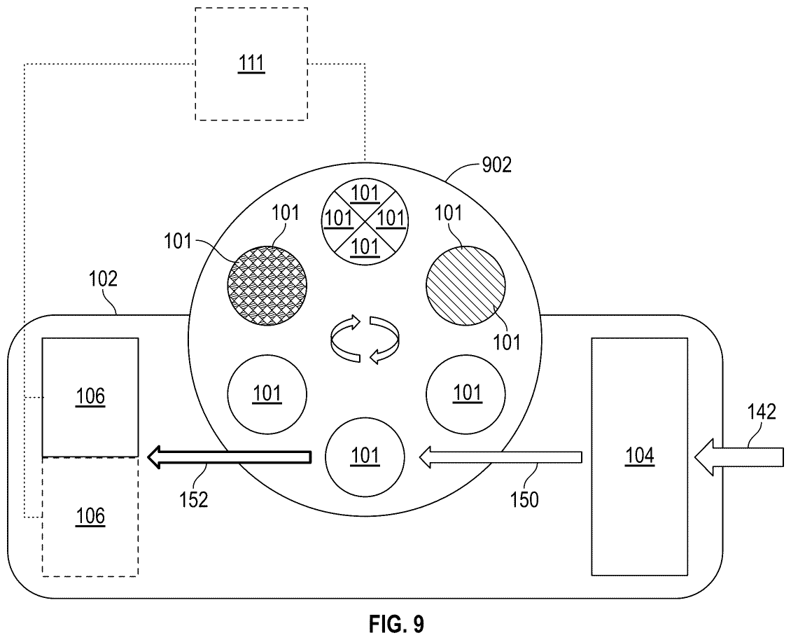

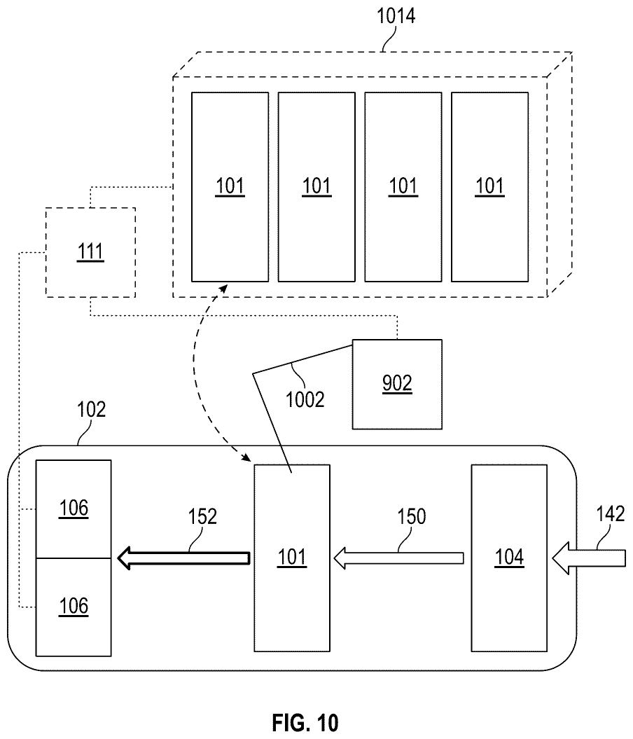

Now referring to FIGS. 1, 9, and 10, some embodiments of the present invention may include a filter selection device 902. The filter selection device 902 may be configured to be carried by an orbital device 100, and the filter selection device 902 may be positioned and configured to selectively moveably position and/or swap-out one or more filter device(s) 101 between one or more lens(es) 104 and the sub-sensor(s) 106. The filter selection device 902 may be configured to moveably position and store filter device(s) 101 that are not being utilized by the light sensor(s) 102 to be stored and/or housed by a filter library 1014. In some embodiments of the present invention, the orbital computer 111 and/or the processor 112 may be configured to selectively control the filter selection device 902 to selectively moveably position and/or swap-out one or more filter device(s) 101 between one or more lens(es) 104 and the sub-sensor(s) 106. The filter selection device 902 may comprise a main body that may be configured to carry and/or hold a plurality of filter devices 101 in a uniform and/or non-uniform pattern, which may be referred to as a pattern of filter devices 101.

The filter selection device 902 and/or the main body may be operable and/or selectively operable to move (and/or rotatably move) relative to the orbital device 100 and/or an adjacent light sensor 102. The movement of the filter selection device 902 and/or the main body may cause the pattern of filter devices 101 to correspondingly move, such that one of the filter devices 101 of the pattern of filter devices 101 may be selectively and/or movably positioned between the lens(es) 104 and the sub-sensor(s) 106.

In some embodiments of the present invention, the filter selection device 902 may comprise a rotatably moveable structure carrying more than one filter device(s) 101, and configured to selectively rotatably move such that one of the filter device(s) 101 may be selectively moveably positioned 101 between one or more lens(es) 104 and the sub-sensor(s) 106. In other embodiments of the present invention, the filter selection device 902 may comprise an actuation device and configured to selectively grasp, move, and/or position the filter device(s) 101 between one or more lens(es) 104 and the sub-sensor(s) 106, and to selectively grasp, move, and/or position the filter device(s) 101 to be stored and/or housed by the filter library 1014.

The filter device(s) 101 carried by the one or more sensor(s) 102 may be chosen by the processor 112 depending upon a mission instruction. The mission instruction may comprise one or more of a mission type and/or a mission parameter. The mission type may relate to one or more of a search mission, a map mission, a report mission, a standby mission, a vigilance mission, a self-diagnostics mission, and/or a statistical analysis mission. The mission parameter may relate to one or more of a target event 304, target events 304, a time constraint (e.g. time range, execution time(s), and/or periodic time(s), periodic time ranges), absorption band(s), portion(s) of the surface of the Earth 140, area(s) of the Earth 140, predetermined target area 154 of Earth 140, and/or exclusion instructions. The orbital computer 111 and/or the processor 112 may determine a predetermined wavelength range based on the mission type and/or mission parameters of the mission instruction. For example, based on the mission instruction, the orbital computer 111 and/or the processor 112 may match one or more filter range(s) 502 to the mission instruction to identify one or more matching filter device(s) 101 having the matched filter range(s) 502 and the processor 112 may selectively control the filter selection device 902 to selectively moveably position and/or swap-out one or more filter device(s) 101 between one or more lens(es) 104 and the sub-sensor(s) 106 with the one or more matching filter device(s) 101.

In some embodiments of the present invention, the filter device(s) 101 may be configured to also convert one or more wavelength(s) of light and/or captured light 150 received by the filter device(s) 101 into one or more other wavelengths of light to form the filtered light 152. In some embodiments of the present invention, the filter device(s) 101 may be configured to also amplify one or more wavelength(s) of light and/or captured light 150 received by the filter device(s) 101 to form the filtered light 152 directed towards the sub-sensor(s) 106. In other embodiments of the present invention, the filter device(s) 101 may be configured to also change the range of the wavelength(s) of the captured light 150 received to form the filtered light 152. For example, without limitation, the filter device(s) 101 may expand the range of the wavelength(s) of the captured light 150 received to form filtered light 152 with wavelengths within the filter range(s) 502 of the light filter device 101 converted to a wider wavelength range.

The orbital computer 111 and/or the processor 112 may be configured to determine, identify, and perform a course of action based on mission instruction(s). The mission instruction may be received by the orbital computer 111 and/or received by the processor 112 from a communication station 122. In some embodiments of the present invention the mission instruction may be generated by the orbital computer 111 and/or by the processor 112 based off of mission data stored in the datastore 114. The mission data may be accessible by the orbital computer 111 and/or the processor 112 and the orbital computer 111 and/or the processor 112 may selectively access the datastore 114 to receive at least a portion of the mission data therefrom. The mission data may comprise saved data of past and/or current/present: mission instruction(s), frames 160, series of frames 160, performed frame rates, timestamps, geolocations, sensed light data, detected target event(s) 304, predetermined target area(s) 154, detected/identified target event(s) 304 and/or courses of action. The orbital computer 111 and/or the processor 112 may be configured to update the mission data stored in the datastore 114 with mission instructions, frames 160, series of frames 160, performed frame rates, timestamps, geolocations, sensed light data, detected target event(s) 304, and/or courses of action upon its occurrence and/or periodically.

The course of action determined and identified based on the mission instructions by the orbital computer 111 and/or the processor 112 may be executable by the orbital computer 111 and/or the processor 112 to cause the orbital computer 111 and/or the processor 112 to, without limitation, selectively communicate with, selectively communicate via, and/or selectively control one or more of the filter device(s) 101, the light sensor(s) 102, the sub-sensor(s) 106, the lens(es) 104, the datastore 114, the network device 116, the power unit 118, the orientation components 113, the communication station(s) 122, filter selection device 902, selection arm 1012, filter library 1014, and/or other orbital device(s) 100 to perform an action and/or perform a series of actions based on the mission instructions. The course of action may comprise a search course of action, a map course of action, a report course of action, a standby course of action, a vigilance course of action, a self-diagnostics course of action, and/or a statistical analysis course of action.

For example, the orbital computer 111 and/or the processor 112 may selectively control the orientation components 113 to orient the orbital device 100, sensor(s) 102, and/or lens(es) 104 to face towards a predetermined target area 154 of Earth 140 that may be related to the mission instructions. The orbital computer 111 and/or the processor 112 may also selectively control the light sensor(s) 102 and/or lens(es) 104 to cause the light sensor(s) 102 and/or lens(es) 104 to rotatably move to face towards a predetermined target area 154 of Earth 140 from the mission parameters. The orbital computer 111 and/or the processor 112 may be utilized in concert with the orientation components 113 and/or the network device 116 to determine and monitor the orientation of the orbital device 100, the light sensor(s) 102, and/or the lens(es) 104 relative to the Earth 140, an area of Earth 140, and/or to a target area 154 and/or predetermined target area 154. For another example, based on the mission instructions, the orbital computer 111 and/or the processor 112 may selectively control the filter selection device 902 to cause the filter selection device 902 to selectively moveably position and/or swap-out one or more filter device(s) 101 between one or more lens(es) 104 and the sub-sensor(s) 106 related to a mission parameter, such as, related to absorption band(s) and/or predetermined target event(s) 304.

Additionally, based on the mission instructions, the orbital computer 111 and/or the processor 112 may selectively control one or more of the light sensor(s) 102 and/or lens(es) 104 to take a frame, perform a frame rate, and/or take a series of frames 160 to receive reflected light 142 from multiple portions and/or areas of the surface of the Earth 140 as the orbital device 100 follows its current orbital path. The orbital computer 111 and/or the processor 112 may determine if one or more target event criteria wavelength(s) and/or target event(s) 304 are present in one or more of the frame(s) 160 and/or the sensed light data of the frame(s) 160, and upon the orbital computer 111 and/or the processor 112 determining and identifying that one or more target event criteria wavelength(s) and/or target event(s) 304 are present in one or more of the frame(s) 160 and/or sensed light data of the frame(s) 160, the orbital computer 111 and/or the processor 112 may transmit those frame(s) 160 and/or sensed light data of those frame(s) 160 to a communication station 122 or other orbital device 100, and/or store those frame(s) 160 and/or sensed light data of those frame(s) 160 in the datastore 114. The orbital computer 111 and/or the processor 112 may also determine and identify if one or more target event criteria wavelength(s) and/or target event(s) 304 are present in one or more of the frame(s) 160 and/or the sensed light data of the frame(s) 160 that match a predetermined target event 304 of the mission instructions.

The orbital computer 111 and/or the processor 112, based on the course of action identified from the mission instructions, may selectively control the orientation components 113 to cause the orbital device 100 to change its current orbit path to a new orbit path. The orbital computer 111 and/or the processor 112 may be utilized in concert with the orientation components 113 and/or the network device 116 to determine and monitor the current orbit path of the orbital device 100 relative to Earth 140. The orbital computer 111 and/or the processor 112 may determine at least one new orbit path based on one or more of the mission instructions, predetermined target area(s) 154, predetermined target event(s) 304, absorption band(s) of target event(s) 304 and/or substance(s), mission data, sensed light data, and/or weather data from the network device 116 and/or GPS data from the orientation components 113. The orbital computer 111 and/or the processor 112 may determine multiple new orbit paths and identify at least one relevant matching new orbit path from the new orbit paths based on one or more of the mission instructions, predetermined target area(s) 154, absorption band(s) of target event(s) 304 and/or substance(s), predetermined target event(s) 304, mission data, sensed light data, and/or weather data from the network device 116 and/or GPS data from the orientation components 113.

In some embodiments, the orbital computer 111 and/or the processor 112 may determine if the filter device(s) 101 utilized in the light sensor(s) 102 have filter range(s) 502 that match the absorption band(s) of target event(s) 304 of the mission instructions. In embodiments that include a filter selection device 902 and/or a filter library 1014, the orbital computer 111 and/or the processor 112 may determine if there are filter device(s) 101 not being utilized in the light sensor(s) 102 that have filter range(s) 502 that match the absorption band(s) of target event(s) 304 of the mission instructions, and selectively control the filter selection device 902 to cause the filter selection device 902 to selectively moveably position and/or swap-out one or more filter device(s) 101 being utilized in the light sensor(s) 102 that do not have filter range(s) 502 that match the absorption band(s) with the one or more filter device(s) 101 that have at least one of the matching filter range(s) 502.

In some embodiments of the present invention, the orbital computer 111 and/or the processor 112 may determine if there are other orbital devices 100 which the orbital computer 111 and/or the processor 112 is, and/or can operably be, in communication therewith. Upon the orbital computer 111 and/or the processor 112 determining that the filter device(s) 101 do not match one or more of the absorption band(s) of the predetermined target event(s) 304 of the mission instructions, the orbital computer 111 and/or the processor 112 may couple in communication with the other orbital device(s) 100 and/or relay at least a portion of the mission instructions to the other orbital device(s) 100 for the other orbital device(s) 100 to perform a course of action based thereupon. For example, without limitation, for the other orbital device(s) 100 to perform a course of action to take frame(s) 160 of predetermined target area(s) 154 of the mission instructions with filter device(s) 101 that have filter range(s) 502 which the original orbital device 100 does not include, and to relay the frame(s) 160 and/or sensed light data associated with the predetermined target area(s) 154 to the original orbital device 100.

Upon the orbital computer 111 and/or the processor 112 determining that the filter device(s) 101 do not match one or more of the absorption band(s) of the predetermined target event(s) 304 of the mission instructions, the orbital computer 111 and/or the processor 112 may emit a filter range error signal to be received by a communication station 122 that may have originally sent the mission instructions to the orbital device 122. In some embodiments, upon the orbital computer 111 and/or the processor 112 determining that the filter device(s) 101 do not match any of the absorption band(s) of the predetermined target event(s) 304 of the mission instructions, the orbital computer 111 and/or the processor 112 may emit a mission error signal to be received by a communication station 122 that may have originally sent the mission instructions to the orbital device 122.

In some embodiments of the present invention, the orbital computer 111 and/or the processor 112 may count and track the number of failed attempts that the orbital device 122 and/or the light sensor(s) 102 have been unable to receive reflected light from an area of Earth 140 and/or from a target area 154 during each orbit passing of the orbital device 100 relative to the area of Earth 140 and/or target area 154. Upon the orbital computer 111 and/or the processor 112 counting each failed attempt, the orbital computer 111 and/or the processor 112 may: determine if the orbital device 100 should change to a new orbit path; and/or determine if the orbital device 100 and/or light sensor(s) 102 are facing the area of Earth 140 and/or target area 154; and/or determine whether another attempt should be made after waiting a predetermined period of time; and/or determine if the count of failed attempts is equal to an upper failed attempts limit. Upon the orbital computer 111 and/or the processor 112 counting and determining that the number of fail attempts is equal to an upper failed attempts limit, the processor may generate and emit a mission error notification signal to the communication station 122 that may have sent the current mission instructions that have led up to the failed attempts by the orbital device 100.

In some embodiments of the present invention, the orbital computer 111 and/or the processor 112 may parse the mission data stored in the datastore 114 to determine and match at least a portion of the mission data to at least a portion of a mission instruction received from a communication station 122. The orbital computer 111 and/or the processor 112 may send the matched mission data to the communication station 122, with the match mission data including one or more of prior or current: mission instruction(s), frames 160, series of frames 160, performed frame rates, timestamps, geolocations, sensed light data, detected target event(s) 304, predetermined target area(s) 154, detected/identified target event(s) 304 and/or courses of action that have been matched to at least a portion of the mission instruction received from the communication station 122.

In some embodiments of the present invention, the orbital computer 111 and/or the processor 112 may determine a high priority area of Earth 140 based on mission instructions received and/or generated. The high priority area of Earth 140 may be determined by the orbital computer 111 and/or the processor 112 based one or more portions of the mission data stored in the datastore 114 and the mission parameters of the mission instructions, such as a predetermined target event 304 of the mission instructions. The high priority target area of Earth 140 may define a portion of the surface of the Earth 140 that may have been calculated by the orbital computer 111 and/or the processor 112 to have a high probability of having the predetermined target event 304 of the mission instructions therein. In some embodiments of the present invention, the orbital computer 111 and/or the processor 112 may be operable to generate a statistical analysis and/or history map at predetermined periodic periods of time and/or based on a mission instruction received from a communication station 122. For example, upon receiving on the mission instruction, the orbital computer 111 and/or the processor 112 may generate a statistical analysis and/or history map based on mission data related to one or more target events 304 detected and identified by the orbital computer 111 and/or the processor 112 to that have and/or were present in one or more areas and/or target areas 154 of the Earth 140 at and/or during one or more periods of time based on the mission instruction. The orbital computer 111 and/or the processor 112 may emit the statistical analysis to be received by the communication station 122.

In some embodiments of the present invention, upon the orbital computer 111 and/or the processor 112 selectively controlling the lens(es) 104 and/or light sensor(s) 102 to take one or more frame(s) 160, the orbital computer 111 and/or the processor 112 may determine a data computation size of the frame(s) 160 taken, which includes the associated sensed light data of the frame(s) 160. The orbital computer 111 and/or the processor 112 may determine if the data computation size is equal to and/or above a predetermined upper data computation size. Upon the orbital computer 111 and/or the processor 112 determining that the data computation size is equal to and/or above the predetermined upper data computation size, the orbital computer 111 and/or the processor 112 may send at least a portion of the frame(s) 160 to other orbital device(s) 100 for the other orbital device(s) 100 to process the frame(s) 160 and identify any target event(s) 304 from the frame(s) 160 received, and send any data relating to identified target event(s) 304 from the frame(s) 160 received back to the original orbital device 100. The orbital computer 111 and/or the processor 112 may also determine and identify any target event(s) 304 from the frame(s) 160 that were not/are not sent to the other orbital device(s) 100 for processing.

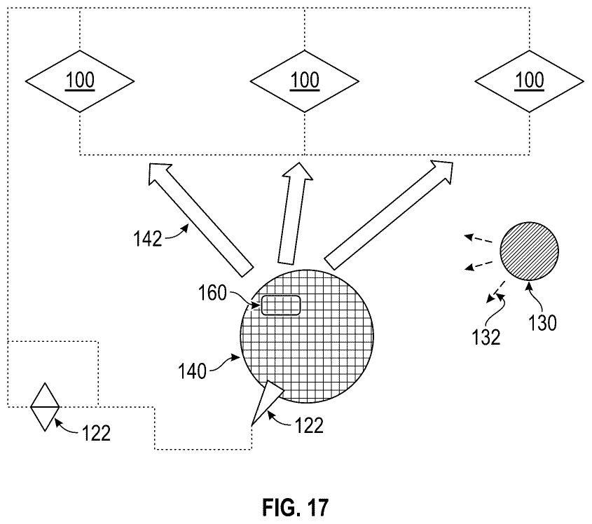

Now referring to FIG. 17, in some embodiments of the present invention the orbital device 100 may be operable in a mesh network configuration. The mesh network configuration may comprise a plurality of orbital devices 100 in communication with one another, and/or may comprise the processors 112 and/or network devices 116 of each of the plurality of orbital devices 100 in communication with at least one of another orbital device's 100 orbital computer 111 and/or the processor 112 and/or network device 116 of the plurality of orbital devices 100. In the mesh network configuration, the orbital devices 100 may send, receive, and/or transceive signals and/or data with one another such as, and without limitation, mission instructions, mission types, mission parameters, mission data, frame(s) 160, frame data, sensed light data, predetermined target area(s) 154, predetermined target event(s) 304, geolocations, orbit paths, current orbit path, new orbit path(s), orbit trajectory(ies), the filter range(s) 502 of the filter device(s) 101 carried by the orbital device 100, courses of action, the target area 154 of the mission instruction of the orbital device 100, target event 304 data, and/or any combinations thereof, which may be referred to as mesh data. Based on the shared mesh data, one or more of the orbital devices 100 of the mesh network configuration may operate in cooperation to perform a course of action identified from mission instructions received by one or more of the orbital devices 100.

For example, without limitation, based on the shared mesh data, one or more of the orbital devices 100 of the mesh network configuration may operate in cooperation to perform a course of action identified from mission instructions that includes one or more predetermined target events 304 and/or predetermined target portions 154 to search for, such that one or more of the orbital devices will share the mission instructions and each search for the predetermined target event(s) 304 and/or each search the predetermined target portion(s) 154 for target event(s) 304. In some embodiments, the orbital devices 100 of the mesh network configuration may share the processing power of each of their processors 112, such that any frames 160 to be processed to determine any if target event(s) 304 can be identified from the sensed light data of the frames 160 may be shared so that the processing power burden is spread to multiple processors 112 across two or more orbital devices 112 of the mesh configuration.

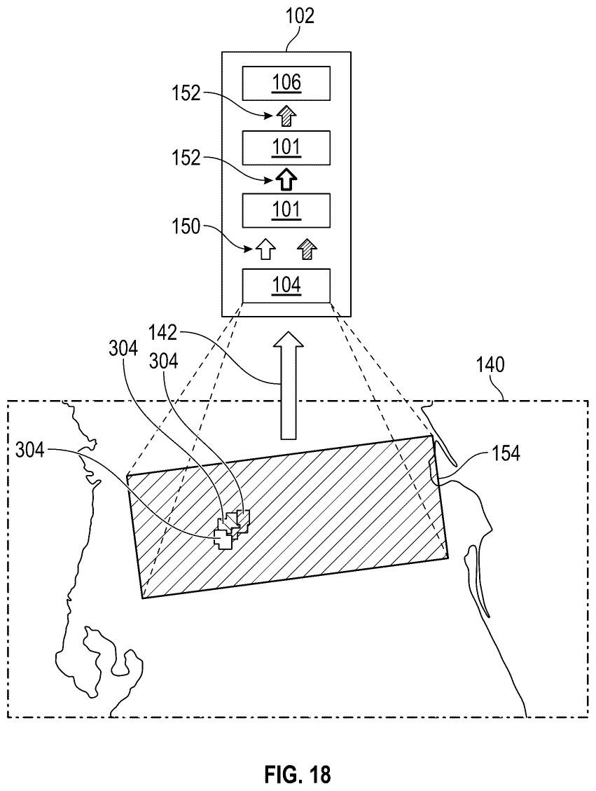

Now referring to FIG. 18, in some embodiments of the present invention, the light sensor(s) 102 of the orbital device 100 may include multiple filter devices 101 positioned in series relative to one another, which, without limitation, may interchangeably be referred to as a series of filter devices 101. The series of the filter devices 101 may be configured to filter captured light 150 and/or filtered light 152 as it is received by each filter device 101 of the series of filter devices 101. For example, without limitation, the lens(es) 104 may receive reflected light 142 from an area of the surface of the Earth 140, a target area 154, and/or a predetermined target area 154 and capture the reflected light 142 as captured light 150 which is directed by the len(es) 104 at a first one of the filter devices 101 in the series of filter devices 101.

The first one of the filter devices 101 may filter the captured light 150 to form filtered light 152 that may be directed to a second filter device 101 in the series of filter devices 101. The second filter device 101 may receive the filtered light 152 from the first one of the filter devices 101 and filter that filtered light 152 received to form a second filtered light 152 which is also then directed towards one or more sub-sensor(s) 106 of the light sensor 102. The sub-sensor(s) 106 may receive the filtered light from the second filter device 101 of the series of filter devices 101 to sensed and/or detect the one or more wavelengths of light that comprise the filtered light 152 and sensed light data.

Despite the above description, it is also contemplated that the series of light filter devices 101 may include two or more light filter devices 101 positioned in series with adjacent light filter devices 101 to form and/or define the series of light filter devices 101. Each light filter device 101 of the series of light filter devices 101 may be configured to filter out at least one wavelength of light from light received thereby, including, without limitation, one or more of captured light 150 and filtered light 152. Each light filter device 101 of the series of light filter devices 101 may be configured to filter one or more wavelengths of light that may differ from the one or more wavelengths of light filtered by the other light filter devices 101 of the series of light filter devices 101.

The filtered light 152 may be received by a light filter device 101 from another light filter device 101 of the series of light filter devices 101, which may be referred to as a partially filtered light 152. Also, the captured light 152 received and filtered by a first light filter device 101 of the series of light filter devices 101 may also be referred to as a partially filtered light 152 and/or a first partially filtered light 152. The filtered light 152 and/or partially filtered light 152 may be referred to a “particular number” of filtered light 152 associated with the position of the light filter device 101 in the series of light filter devices 101.

For example, without limitation, the partially filtered light 152 from a light filter device 101 positioned second or third in the series of light filter devices 101 relative to the lens 104, may be referred to as a second or third partially filtered light 152. Additionally, the filtered light 152 and/or partially filtered light 152 for a last one of the light filter devices 101 of the series of light filter devices 101 may be referred to as filtered light 152, last filtered light 152, resulting filtered light 152, and/or final filtered light 152, without limitation.

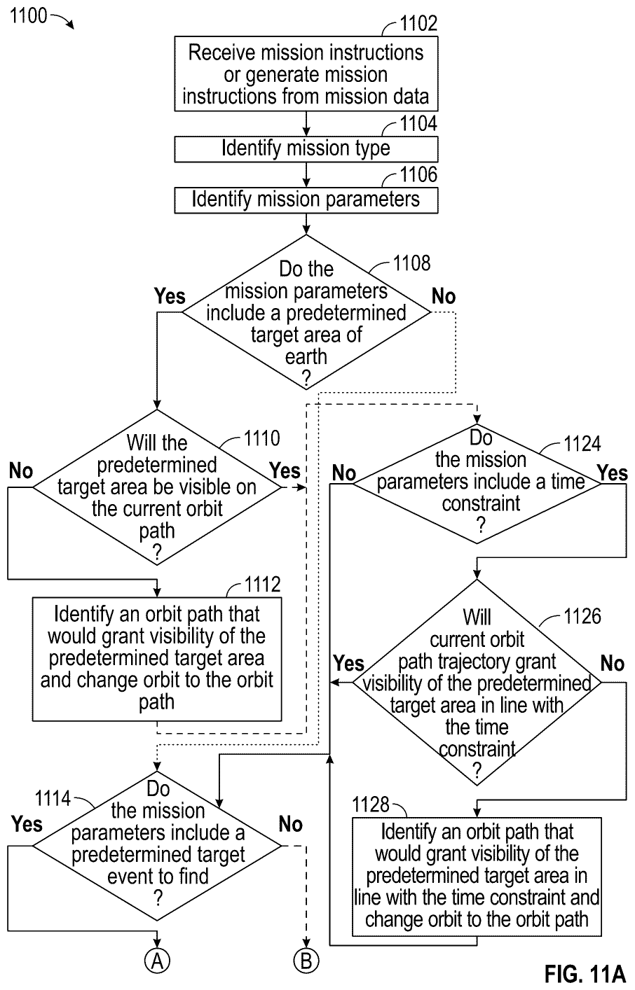

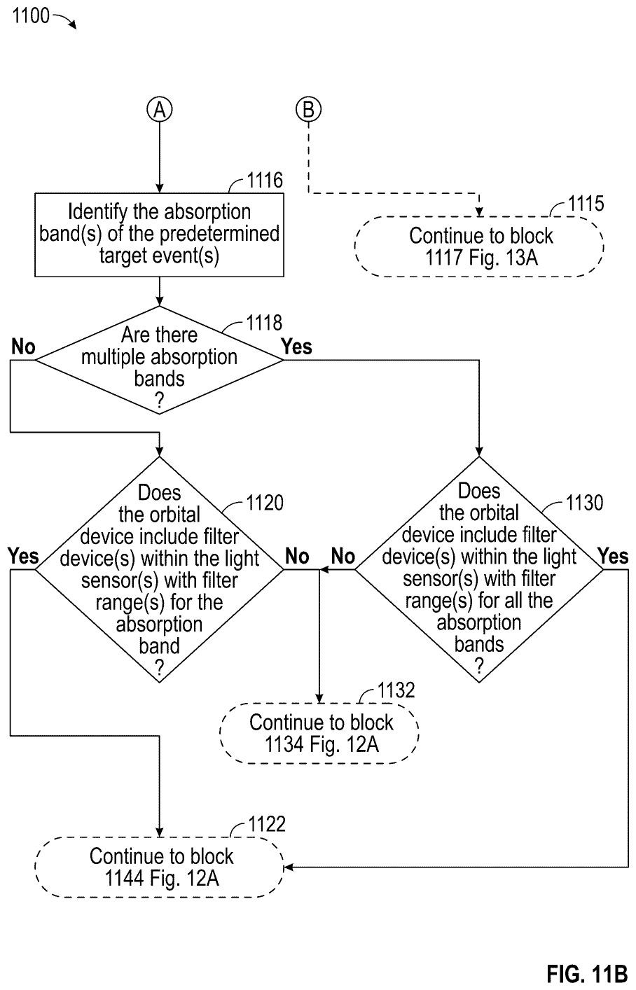

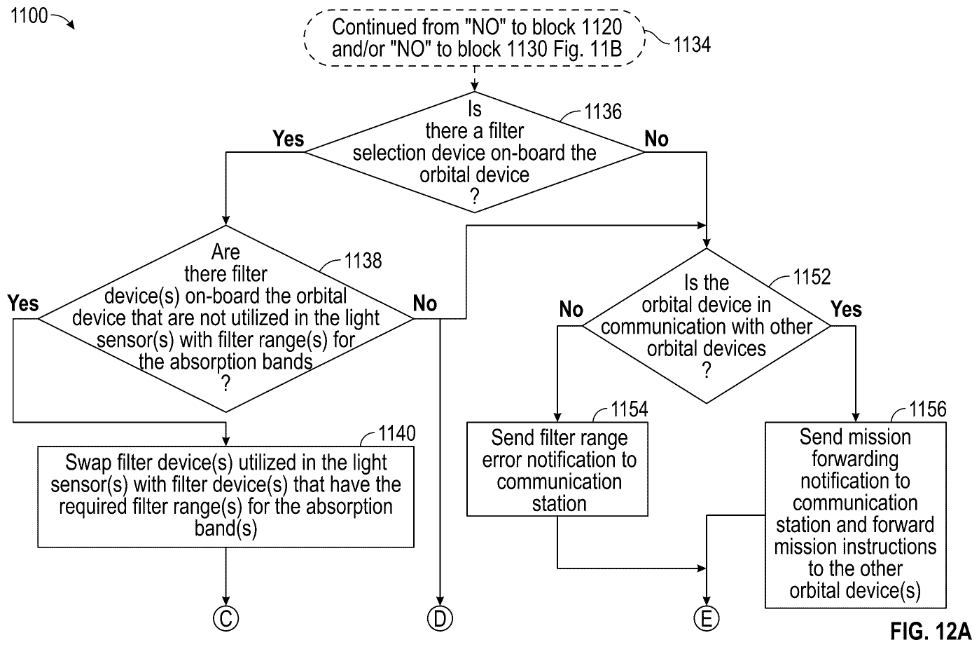

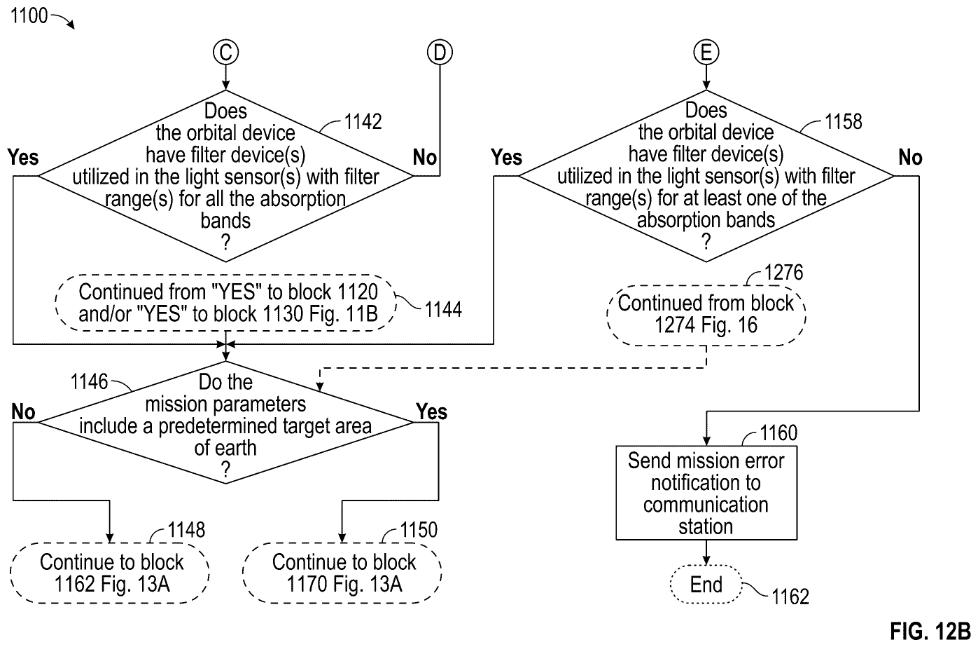

Now referring to FIGS. 11A-16, a method aspect 1100 of some embodiments of the present invention is illustratively shown. The method aspect 1100 may be performed by some embodiments of an orbital device 100 as described herein upon receiving and/or generating mission instructions. For further increased terseness, and for the purposes of the description of method aspect 1100 of embodiments of the present invention, it should be understood that the terms orbital device 100 and orbital computer 111 may be used interchangeably and may be used to reference any one of the filter device(s) 101, the light sensor(s) 102, the lens(es) 104, the sub-sensor(s) 106, the processor 112, the datastore 114, the network device 116, the power unit 118, the orientation component(s) 113, the filter selection device(s) 902, the selection arm(s) 1002, and the filter library(ies) 1014 individually, entirely all together, and/or in any combination or combinations thereof without limitation.

Starting at Block 1102 illustratively shown in FIG. 11A, orbital device 100 may receive mission instructions, and/or the orbital device 100 may generate mission instructions based on the mission data that may include one or more of saved data of past and/or current/present: mission instruction(s), frames 160, series of frames 160, performed frame rates, timestamps, geolocations, sensed light data, detected target event(s) 304, predetermined target area(s) 154, detected/identified target event(s) 304 and/or courses of action. The orbital device 100 may then continue to Block 1104 and identify a mission type of/from the mission instructions, and may then continue to Block 1106 and identify mission parameters of/from the mission instructions. The orbital device 100 may then continue to Block 1108 and determine whether the mission parameters include a predetermined target area 154 of Earth 140. If, at Block 1108 the orbital device 100 determines that the mission parameters do not include a predetermined target area 154 of Earth 140, then the orbital device 100 may continue to Block 1114 to determine whether the mission parameters include a predetermined target event 304 to find. If, however, at Block 1108 the orbital device 100 determines that the mission parameters do include a predetermined target area 154 of Earth 140, the orbital device 100 may then continue to Block 1110 and determine whether the predetermined target area 154 will be visible on the current orbit path of the orbital device 100. However, at Block 1110, if the orbital device 100 determines that the predetermined target area 154 will not be visible from the current orbit path of the orbital device 100, then the orbital device 100 may move to Block 1112 to identify and orbit path that would grant visibility of the predetermined target area 154 and change its orbit to that identified orbit path.

The orbital device 100 may then continue to Block 1124 to determine whether the mission parameters include a time constraint. If, at Block 1124 the orbital device 100 determines that the mission parameters include a time constraint, the orbital device 100 may continue to Block 1126 to determine if the current orbital path trajectory of the orbital device 100 will grant visibility of the predetermined target area in line with the time constraint. If, at Block 1126 the orbital device 100 determines that the current orbital path trajectory of the orbital device 100 will grant visibility of the predetermined target area in line with the time constraint, the orbital device 100 may then continue to Block 1114 to determine whether the mission parameters include a predetermined target event 304 to find. If, however, at Block 1126, the orbital device 100 determines that determines that the current orbital path trajectory of the orbital device 100 will not grant visibility of the predetermined target area in line with the time constraint, then the orbital device 100 may continue to Block 1128 to identify an orbit path that would grant visibility of the predetermined target area in line with the time constraint and change orbit to that orbit path. Then, from Block 1128, the orbital device 100 may continue to Block 1114. If, however, at Block 1124 the orbital device 100 determined that the mission parameters do not include a time constraint, then the orbital device 100 may continue directly to Block 1114 to determine if the mission parameters include a predetermined target event to find.

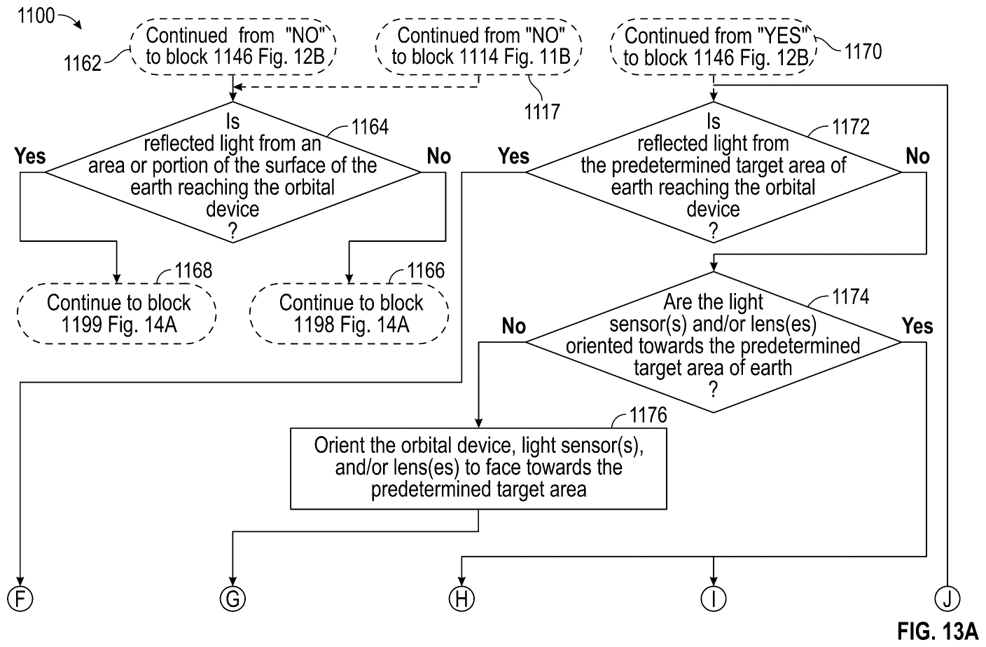

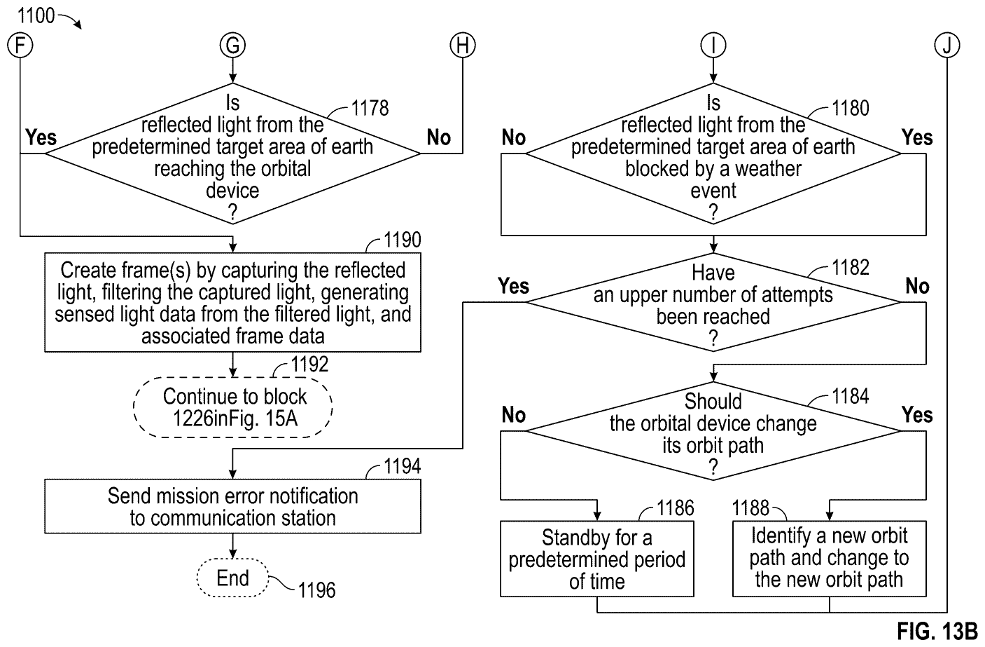

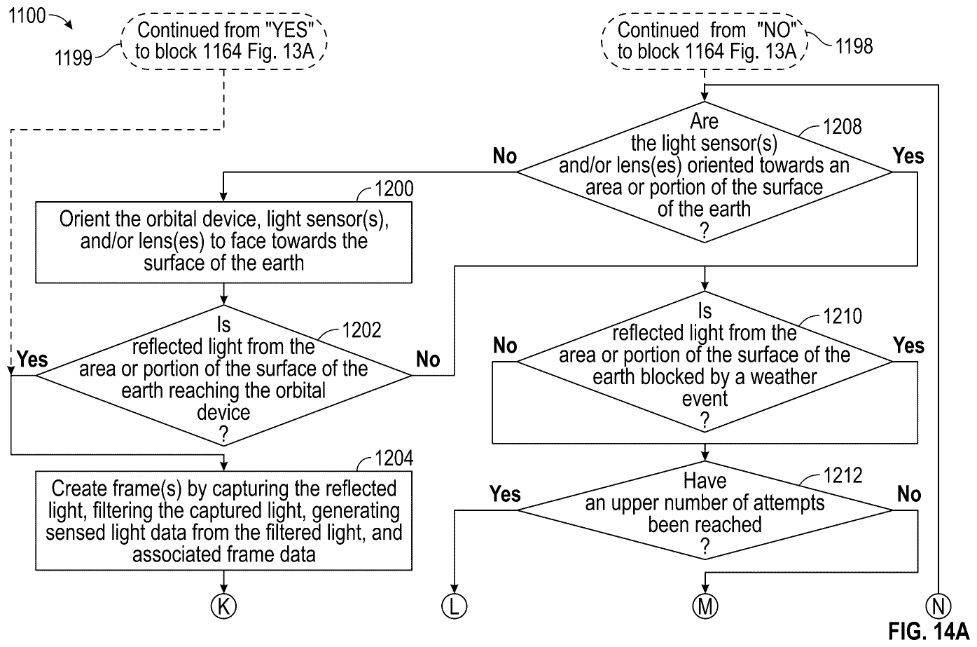

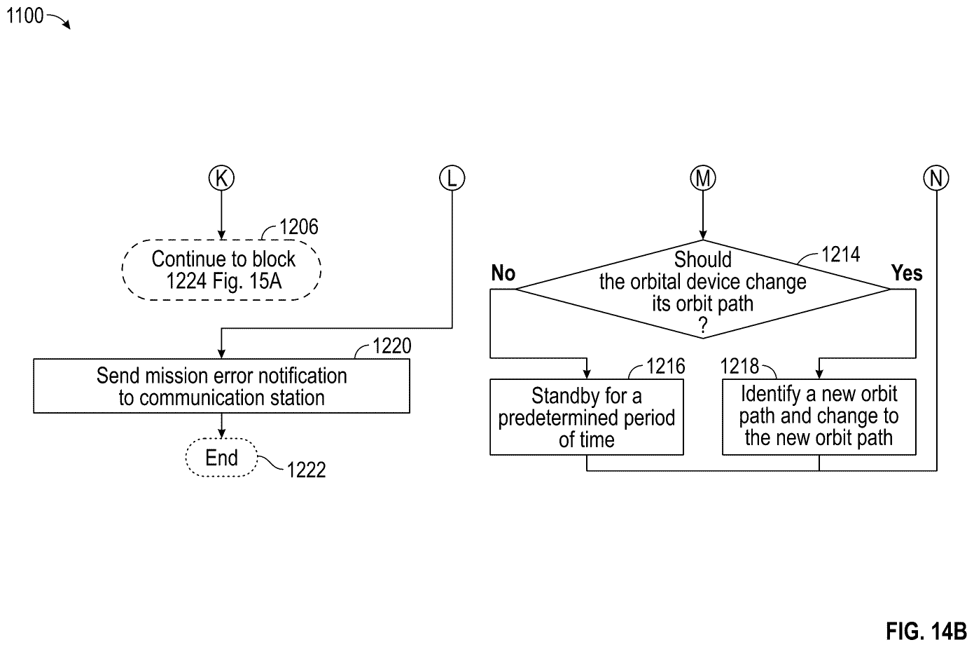

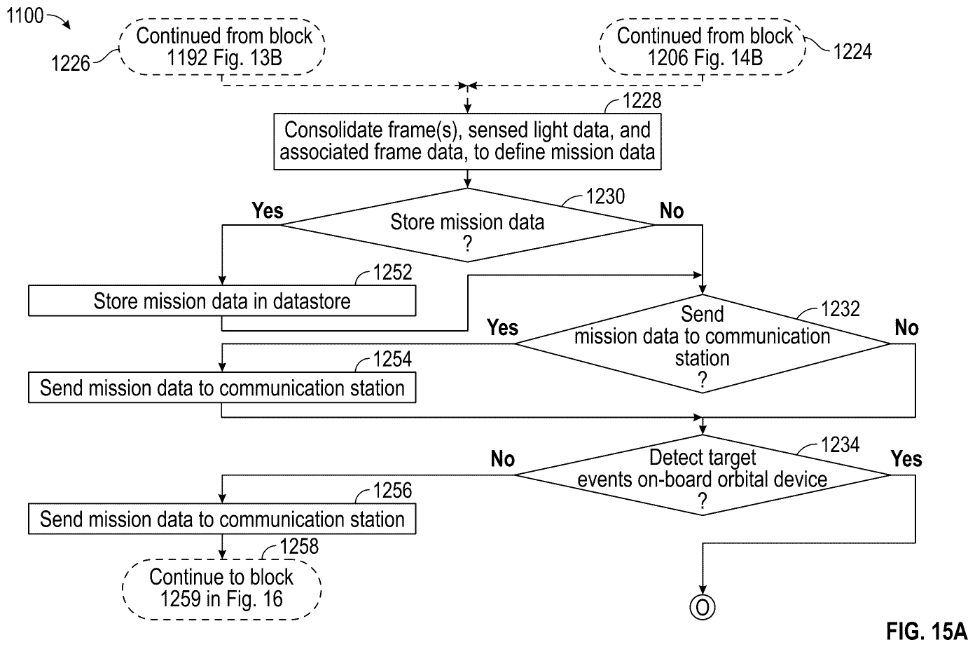

At Block 1114, if the orbital device 100 determines that the mission parameters do not include a predetermined target event to find, then the orbital device 100 may continue to Block 1115 and move to Block 1117 in FIG. 13A. If, however, at Block 1114 the orbital device 100 determined that the mission parameters do include a predetermined target event to find, then the orbital device 100 may continue to Block 1116 to identify the absorption pant(s) of the predetermined target event(s). From Block 1116, the orbital device 100 may then continue to Block 1118 to determine if there are multiple absorption bands identified from the predetermined target event(s). If, at Block 1118, the orbital device 100 determines that there are multiple absorption bands identified from the predetermined target event(s), then the orbital device 100 may continue to Block 1130 to determine if there are filter device(s) 101 carried by the light sensor(s) 102 of the orbital device 100 have filter range(s) 502 for all of the identified absorption bands. If, at Block 1130 the orbital device 100 determines that there are filter device(s) 101 carried by the light sensor(s) 102 of the orbital device 100 have filter range(s) 502 for all of the identified absorption bands, then the orbital device 100 may continue to Block 1122 to move to Block 1144 on FIG. 12B. If, however, at Block 1130 the orbital device 100 determines that there are filter device(s) 101 carried by the light sensor(s) 102 of the orbital device 100 do not have filter range(s) 502 for all of the identified absorption bands, then the orbital device 100 may continue to Block 1132 to move to Block 1134 in FIG. 12B.

If, however, at Block 1118 the orbital device 100 determines that there is only a single absorption band identified from the predetermined target events of the mission parameters, then the orbital device 100 may continue to Block 1120 to determine if the orbital device 100 includes filter device(s) 101 carried by the light sensor(s) 102 that have the filter range(s) 502 for the single absorption band identified. If, at Block 1120, the orbital device 100 determines that there are filter device(s) 101 carried by the light sensor(s) 102 of the orbital device 100 have filter range(s) 502 for the identified absorption band, then the orbital device 100 may continue to Block 1122 to move to Block 1144 on FIG. 12B. If, however, at Block 1120 the orbital device 100 determines that there are filter device(s) 101 carried by the light sensor(s) 102 of the orbital device 100 do not have filter range(s) 502 for the identified absorption band, then the orbital device 100 may continue to Block 1132 to move to Block 1134 in FIG. 12A.

Now referring to FIG. 12A, at Block 1134, the orbital device 100 continues the method 1100 from a determination of “no” to either Block 1120 or Block 1130 and may then move to Block 1136 to determine if there is a filter selection device 902 onboard the orbital device 100. If, at Block 1136, the orbital device 100 determined that there is a filter selection device 902 onboard the orbital device 100, then the orbital device 100 may continue to Block 1138 to determine if there are filter device(s) 101 on board the orbital device 100 that are not currently utilized in the light sensor(s) 102 that have filter range(s) 502 for the absorption band(s) to replace any filter device(s) 101 that are currently utilized in the light sensor(s) 102 which have filter range(s) 502 inapplicable to the identified absorption band(s). If, at Block 1138, the orbital device 100 determines that there are filter device(s) 101 on board the orbital device 100 that are not currently utilized in the light sensor(s) 102 that have filter range(s) 502 for the absorption band(s), then the orbital device 100 may continue to Block 1140 to swap the filter device(s) 101 utilized in the light sensor(s) 102 with filter device(s) that have the required filter range(s) 502 for the identified absorption band(s). Then, from Block 1140, the orbital device 100 may continue the method 1100 to move to Block 1142 to determine if the orbital device 100 now has filter device(s) 101 utilized in the light sensor(s) 102 with filter range(s) 502 for all the identified absorption band(s).

If, at Block 1142, the orbital device 100 determines that the orbital device 100 now has filter device(s) 101 utilized in the light sensor(s) 102 with filter range(s) 502 for all the identified absorption band(s), then the orbital device 100 may continue to Block 1146 to determine if the mission parameters include a predetermined target area of Earth 140. If, however, the orbital device 100 determines and answer of “no” to any of Blocks 1136, 1138, or 1142, then the orbital device 100 may move to Block 1152 to determines if the orbital device 100 is in communication with other orbital device(s) 100. If, at Block 1152 the orbital device 100 determines that the orbital device 100 is in communication with other orbital device(s) 100, then the orbital device 100 may continue to Block 1156 to send a mission forwarding notification to the communication station(s) 122 and to forward the mission instructions to the other orbital device(s) 100 for the other orbital device(s) 100 to perform at least a portion thereof. Then, the orbital device 100 may continue the method 1100 to Block 1158 to determine if the orbital device 100 has filter device(s) 101 utilized in the light sensor(s) 102 having filter range(s) 502 for at least one of the identified absorption band(s). If, at Block 1158, the orbital device 100 determined that it does not have filter device(s) 101 utilized in the light sensor(s) 102 having filter range(s) 502 for at least one of the identified absorption band(s), then the orbital device 100 may continue to Block 1160 to send a mission error notification to the communication station(s) 122 and then move to Block 1162 to end the method 1100.

If, however, at Block 1158, the orbital device 100 determines that the orbital device 100 has filter device(s) 101 utilized in the light sensor(s) 102 that have filter range(s) 502 for at least one of the identified absorption band(s), then the orbital device 100 may instead move to Block 1146 to determine if the mission parameters include a predetermined target area of Earth 140. If, however, the orbital device 100 determines an answer of “no” to either of Blocks 1120 or 1130, then the orbital device 100 may continue directly to Block 1146 from Blocks 1120 or 1130. If, at Block 1146, the orbital device 100 determines that the mission parameters do not include a predetermined targe area of Earth 140, then the orbital device 100 may continue to Block 1148 to then move to Block 1162 in FIG. 13A. If, however, at Block 1146, the orbital device 100 determines that the mission parameters do include a predetermined targe area of Earth 140, then the orbital device 100 may continue to Block 1150 to then move to Block 1170 in FIG. 13A.

Now referring to FIG. 13A, the orbital device 100 may continue to Block 1162 upon determining an answer of “no” to Block 1146 in FIG. 12B to determine if reflected light 142 from an area or portion of the surface of the Earth 140 is reaching the orbital device 100. If, however, at Block 1114 in FIG. 11A, the orbital device 100 determined an answer of “no,” then the orbital device 100 may proceed directly to Block 1164 from Block 1114. If, at Block 1164, the orbital device 100 determined that reflected light 142 from an area or portion of the surface of the Earth 140 is reaching the orbital device 100, then the orbital device 100 may continue to Block 1168 to move to Block 1199 in FIG. 14A. If, however, at Block 1164 the orbital device 100 determines that reflected light 142 from an area or portion of the surface of the Earth 140 is not reaching the orbital device 100, then the orbital device 100 may continue to Block 1166 to move to Block 1198 in FIG. 14A.

If, however, at Block 1146, the orbital device 100 determined an answer of “no,” then the orbital device 100 may instead continue to Block 1170 and move to Block 1172 from Block 1146. At Block 1172, the orbital device 100 may determine if reflected light 142 from a predetermined target area 154 of Earth 140 is reaching the orbital device 100. If, the orbital device 100 determines that reflected light 142 from a predetermined target area 154 of Earth 140 is reaching the orbital device 100, then the orbital device 100 may continue to Block 1190 to create frame(s) 160 by capturing the reflected light 142 to form captured light 150, filtering the captured light 150 to form filtered light 152, generating sensed light data from the filtered light 152, and associating frame data with each frame 160. If, however, at Block 1172, the orbital device 100 determines that the reflect light 142 from the predetermined target area 154 of Earth 140 is not reaching the orbital device 100, then the orbital device 100 may instead move to Block 1174 from Block 1172.

At Block 1174, the orbital device 100 may determine if the light sensor(s) 102 and/or lens(es) 104 are oriented towards the predetermined target area 154 of Earth 140. If, the orbital device 100 determines that the light sensor(s) 102 and/or lens(es) 104 are not oriented towards the predetermined target area 154 of Earth 140, then the orbital device 100 may move to Block 1176 to selectively control the orientation components 113, the light sensor(s) 102, and/or the lens(es) 104 to orient the light sensor(s) 102 and/or the lens(es) 104 to face towards the predetermined target area 154. Then, from Block 1176, the orbital device 100 may continue to Block 1178 to again determine if reflected light 142 is reaching the orbital device 100 from the predetermined target area 154. If, the orbital device 100 determines that reflected light 142 is reaching the orbital device 100 from the predetermined target area 154, then the orbital device 100 may continue to Block 1190 to create frame(s) 160 by capturing the reflected light 142 to form captured light 150, filtering the captured light 150 to form filtered light 152, generating sensed light data from the filtered light 152, and associating frame data with each frame 160.

If, however, at Block 1178, the orbital device 100 determines that reflected light 142 from the predetermined target area 154 is not reaching the orbital device 100, then the orbital device 100 may instead move to Block 1180 to determine if the reflected light 142 from the predetermined target area 154 of Earth 140 is Block by a weather event. However, if at Block 1174, the orbital device 100 determines that the light sensor(s) 102 and/or the lens(s) 104 are not oriented towards the predetermined target area 154 of Earth 140, then the orbital device 100 may continue directly to Block 1180 from 1174 to determine if the reflected light 142 from the predetermined target area 154 of Earth 140 is Block by a weather event. At Block 1180, whether the orbital device 100 determines and answer of “yes” or “no” whether the reflected light 142 from the predetermined target area 154 of Earth 140 is blocked by a weather event, the orbital device 100 may continue to Block 1182 to determine if a number of attempts by the orbital device 100 to receive reflected light 142 from the predetermined target area 154 of Earth 140 has reach a number that is equal to or greater than an upper number of attempts. If the orbital device 100 determines an answer of “yes” to Block 1182, then the orbital device 100 may continue to Block 1194 to send a mission error notification to the communication station(s) 122 and then move to Block 1196 to end the method 1100.

If, however, the orbital device 100 determines an answer of “no” to Block 1182, then the orbital device 100 may instead continue to Block 1184 from Block 1182. At Block 1184, the orbital device 100 may determine if the orbital device 100 should change its orbit path. If the orbital device 100 determines that the orbital device 100 should not change its orbit path, then the orbital device 100 may move to Block 1186 to continue its current orbit path and standby for a predetermined period of time. The, from Block 1186, the orbital device 100 may continue to Block 1172 to again determine if reflected light 142 from the predetermined target area 154 of Earth 140 is reaching the orbital device 100 and continue the method 1100. If, however, at Block 1184 the orbital device 100 determines that it should not change its orbit path, then the orbital device 100 may instead continue to Block 1188 to identify a new orbit path and to change its orbit path to the new orbit path. Then, from Block 1188, the orbital device 100 may continue to Block 1172 to again determined if reflected light 142 from the predetermined target area 154 of Earth 140 is reaching the orbital device 100 and continue the method 1100.

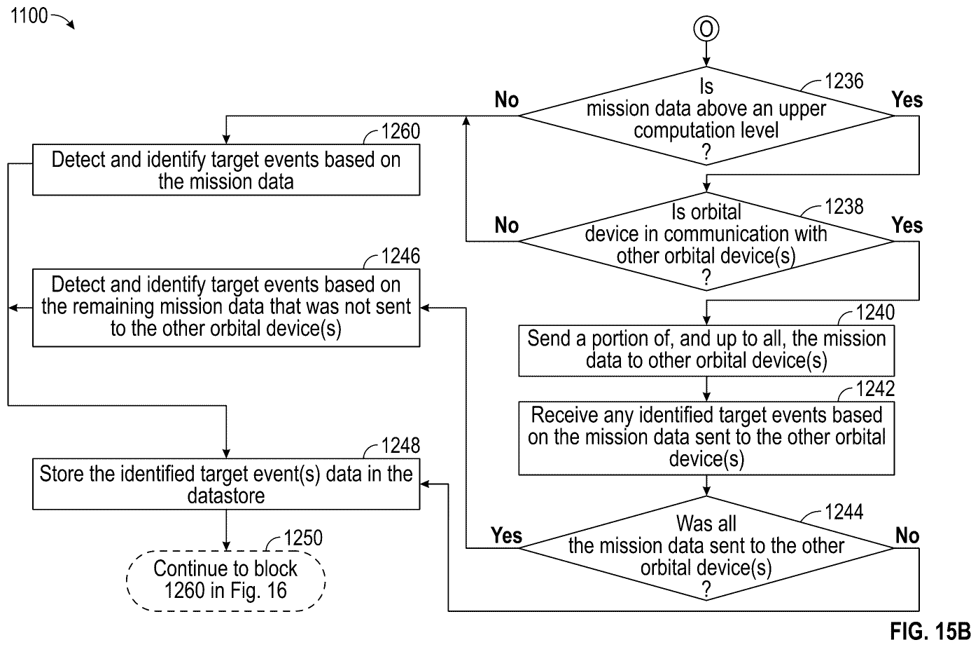

Now referring to FIG. 14A, if the orbital device 100 determined an answer of “yes” to Block 1164 in FIG. 13A, then the orbital device 100 may continue directly to Block 1199 from Block 1164 to then move to Block 1204 to create frame(s) 160 from the reflected light 142 received from an area/portion of the surface of the Earth 140 by capturing the reflected light 142 to form captured light 150, filtering the captured light 150 to form filtered light 152, generating sensed light data from the filtered light 152, and associating frame data with each frame 160. Then, from Block 1204, the orbital device 100 may continue the method 1100 to Block 1206 to then move to Block 1224 in FIG. 15A.

If, however, the orbital device 100 determined an answer of “no” back at Block 1164 in FIG. 13A, then the orbital device 100 may instead continue to Block 1198 from Block 1164 to then move to Block 1208 to determine if the light sensor(s) 102 and/or lens(es) 104 of the orbital device 100 are oriented towards an area/portion of the surface of the Earth 140. If, the orbital device 100 determines that the light sensor(s) 102 and/or lens(es) 104 of the orbital device 100 are not oriented towards an area/portion of the surface of the Earth 140, then the orbital device 100 may continue to Block 1200 to selectively control the orientation components 113, the light sensor(s) 102, and/or the lens(es) 104 to orient the light sensor(s) 102 and/or the lens(es) 104 to face towards an area/portion of the surface of the Earth 140. Then, from Block 1200, the orbital device 100 may continue to Block 1202 to again determine if reflected light 142 is reaching the orbital device 100 from an area/portion of the surface of the Earth 140. If, at Block 1202, the orbital device 100 determines that reflected light 142 is reaching the orbital device 100 from an area/portion of the surface of the Earth 140, then from Block 1202 the orbital device 100 may move to Block 1204 to create frame(s) 160 from the reflected light 142 received from an area/portion of the surface of the Earth 140 by capturing the reflected light 142 to form captured light 150, filtering the captured light 150 to form filtered light 152, generating sensed light data from the filtered light 152, and associating frame data with each frame 160.

If, however, at Block 1202, the orbital device 100 determines that reflected light 142 is not reaching the orbital device 100 from an area/portion of the surface of the Earth 140, then from Block 1202 the orbital device 100 may instead move to Block 1210 to determine if reflected light 142 from an area/portion of the surface of the Earth 140 is being blocked by a weather event. If, however, at Block 1208, the orbital device 100 determined that the light sensor(s) 102 and/or lens(es) 104 of the orbital device 100 are oriented towards an area/portion of the surface of the Earth 140, then the orbital device 100 may proceed directly to Block 1210 from Block 1208. At Block 1210, whether the orbital device 100 determines an answer of “yes” or “no” to whether reflected light 142 from an area/portion of the surface of the Earth 140 is being blocked by a weather event, the orbital device 100 may continue to Block 1212 to determine if a number of attempts by the orbital device 100 to receive reflected light 142 from an area/portion of the surface 154 of Earth 140 has reach a number that is equal to or greater than an upper number of attempts. If the orbital device 100 determines an answer of “yes” to Block 1212, then the orbital device 100 may continue to Block 1220, to send a mission error notification to the communication station(s) 122 and then move to Block 1222 to end the method 1100.

If, however, the orbital device 100 determines an answer of “no” to Block 1212, then the orbital device 100 may instead continue to Block 1214 from Block 1212. At Block 1214, the orbital device 100 may determine if the orbital device 100 should change its orbit path. If the orbital device 100 determines that the orbital device 100 should not change its orbit path, then the orbital device 100 may move to Block 1216 to continue its current orbit path and standby for a predetermined period of time. Then, from Block 1216, the orbital device 100 may continue to Block 1208 to again determine if reflected light 142 from an area/portion of the Earth 140 is reaching the orbital device 100 and continue the method 1100. If, however, at Block 1214, the orbital device 100 determines that it should not change its orbit path, then the orbital device 100 may instead continue to Block 1218 to identify a new orbit path and to change its orbit path to the new orbit path. Then, from Block 1218, the orbital device 100 may continue to Block 1208 to again determined if reflected light 142 from an area/portion of the Earth 140 is reaching the orbital device 100 and continue the method 1100.

Now referring to FIG. 15A, the method 1100 may be continued by the orbital device 100 to Block 1228 from either, Block 1226 from Block 1192 of FIG. 13B, or also to Block 1228 from Block 1224 from Block 1206 of FIG. 14B. At Block 1228, the orbital device 100 may consolidate the frame(s) 160, the sensed light data, and the associated frame data to define mission data. Then the orbital device 100 may continue to Block 1230 to determine whether to store the mission data in the datastore 114. If, at Block 1230, the orbital device 100 determines that is should store the mission data, then the orbital device 100 may move to Block 1252 to store the mission data in the datastore 114 and then move to Block 1232. If, however, at Block 1230, the orbital device 100 determines that it should not store the mission data, then the orbital device 100 may proceed directly to Block 1232 from Block 1230.

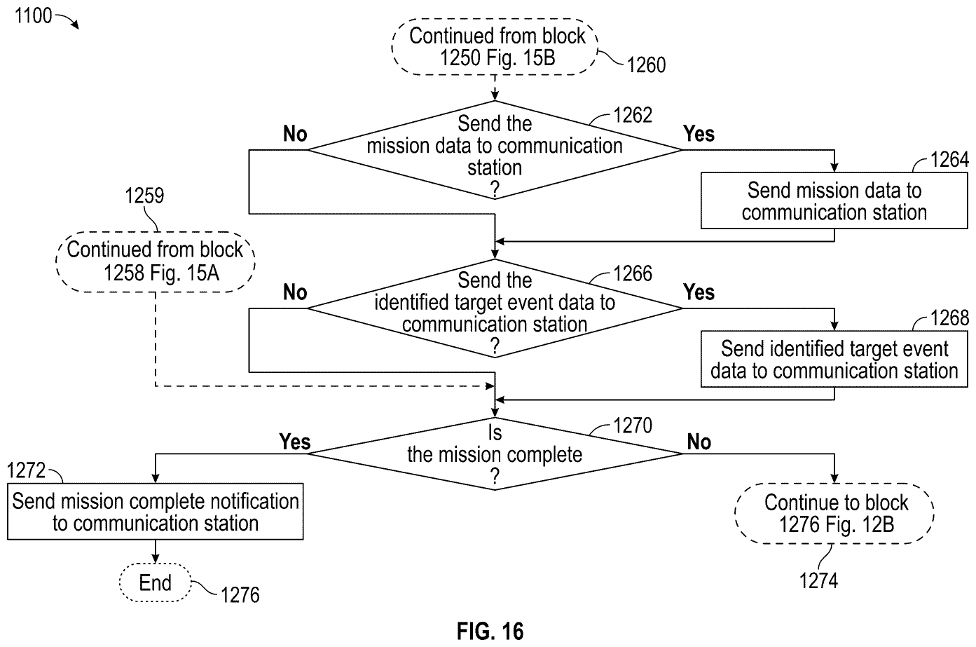

At Block 1232, the orbital device 100 may determine whether to send the mission data to the communication station(s) 122. If, at Block 1232, the orbital device 100 determines that it should send the mission data to the communication station(s) 122, then the orbital device 100 may continue to Block 1254 to send the mission data to the communication station(s) 122. From Block 1254 the orbital device 100 may continue to Block 1234 to determine if target events 304 are to be identified from the mission data, frames, and/or sensed light data by the orbital device 100. However, if at Block 1232 the orbital device 100 determines that it should not send the mission data to the communication station(s) 122, then the orbital device 100 may continue the method 1100 directly to Block 1234. If, at Block 1234, the orbital device 100 determines that it should not identify target events 304 from the mission data, frames, and/or sensed light data by the orbital device 100, then the orbital device 100 may continue to Block 1256 and send the mission data, frame(s), frame data, and/or sensed light data to the communication station(s) 122 for the communication station(s) 122 to parse the mission data, frame(s), frame data, and/or sensed light data to identify any target event(s) 304 therefrom. Then, from Block 1256, the orbital device 100 may continue to Block 1258 to then move to Block 1259 illustratively shown in FIG. 16.

If, however, at Block 1234 the orbital device 100 determines that target event(s) 304 are to be detected and identified by the orbital device 100, and not by another system, then the orbital device 100 may continue to Block 1236 to determine whether the mission data has a file data size that is equal to and/or above an upper computation level. If the orbital device 100 determines that the mission data has a file data size that is equal to and/or above an upper computation level, then the orbital device 100 may continue to Block 1238 to determine whether the orbital device 100 is in communication with one or more other orbital device(s) 100. If the orbital device 100 determines that it is in communication with one or more other orbital device(s) 100, then the orbital device 100 may move to Block 1240 to send a portion of, and up to all, the mission data, frame(s), frame data, and/or sensed light data to the other orbital device(s) 100 for the other orbital device(s) 100 to parse the mission data, frame(s), frame data, and/or sensed light data to identify any target event(s) 304 therefrom. From Block 1240, the orbital device 100 may then continue to Block 1242 to receive any identified target event(s) 304 from the other orbital device(s) 100 that were identified by the other orbital device(s) 100 from the mission data, frame(s), frame data, and/or sensed light data that was sent thereto.

From Block 1242, the orbital device 100 may move to Block 1244 to determine if all the mission data, frame(s), frame data, and/or sensed light data was sent to the other orbital device(s) 100 for the other orbital device(s) 100 to parse the mission data, frame(s), frame data, and/or sensed light data to identify any target event(s) 304 therefrom. If, at Block 1242, the orbital device 100 determines that it did not send all the mission data, frame(s), frame data, and/or sensed light data to the other orbital device(s) 100, then the orbital device 100 may continue to Block 1246 to detect and identify target event(s) 304 based on the remaining mission data, frame(s), frame data, and/or sensed light data that was not sent to the other orbital device(s) 100. Then, from Block 1246, the orbital device 100 may continue to Block 1248 to store the identified target event(s) 304 data in the datastore 114. If, however, at Block 1244, the orbital device 100 determines that all the mission data, frame(s), frame data, and/or sensed light data was sent to the other orbital device(s) 100, then the orbital device 100 may continue directly to Block 1248 from Block 1244 and continue the method 1100 therefrom.

If, however, that orbital device 100 determines an answer of “no” to either of Block 1236 or 1238, then the orbital device 100 may continue the method 1100 to Block 1260 to detect and identify target events 304 from the mission data, frame(s), frame data, and/or sensed light data. Then, from Block 1260, the orbital device 100 may continue to Block 1248 to store the identified target event(s) 304 data in the datastore 114.

Now additionally referring to FIG. 16, from Block 1248, the orbital device 100 may continue the method 1100 to Block 1250 and move to Block 1260. From Block 1260, the orbital device 100 may continue to Block 1262 to determine whether to send the mission data, frame(s), frame data, and/or the sensed light data to the communication station(s) 122. If the orbital device 100 determines that it should send the mission data, frame(s), frame data, and/or the sensed light data to the communication station(s) 122, then the orbital device 100 may move to Block 1264 to send the mission data, frame(s), frame data, and/or the sensed light data to the communication station(s) 122. Then from Block 1264, the orbital device 100 may continue to Block 1266 to determine whether to send the identified target event(s) 304 data to the communication station(s) 122.

If, however, at Block 1262, the orbital device 100 determines that it should not send the mission data, frame(s), frame data, and/or the sensed light data to the communication station(s) 122, the orbital device 100 may then continue directly to Block 1266 to determine whether to send the identified target event(s) 304 data to the communication station(s) 122. At Block 1266, if the orbital device 100 determines that it should send the identified target event(s) 304 data to the communication station(s) 122, then the orbital device 100 may move to Block 1268 to send the identified target event(s) 304 data to the communication station(s) 122. Then, from Block 1268, the orbital device 100 may continue to Block 1270 to determine whether the mission has been completed based on the mission instructions, the identified mission type, the identified mission parameters, the mission data, frame(s), the frame data, and/or the sensed light data.

If, however, at Block 1266, the orbital device 100 determines that it should not send the identified target event(s) 304 data to the communication station(s) 122, then from Block 1266 the orbital device 100 may continue directly to Block 1270 to determine whether the mission has been completed based on the mission instructions, the identified mission type, the identified mission parameters, the mission data, frame(s), the frame data, and/or the sensed light data. As mentioned above, if the orbital device 100 is at Block 1258, the orbital device 100 may continue the method 1100 from Block 1258 in FIG. 15A to Block 1259 in FIG. 16 to then move to Block 1270 to determine whether the mission has been completed based on the mission instructions, the identified mission type, the identified mission parameters, the mission data, frame(s), the frame data, and/or the sensed light data.

At Block 1270, if the orbital device 100 determines that the mission has been completed based on the mission instructions, the identified mission type, the identified mission parameters, the mission data, frame(s), the frame data, and/or the sensed light data, then the orbital device 100 may continue to Block 1272 to send a mission complete notification to the communication station(s) 122. Then from Block 1272, the orbital device 100 may continue to Block 1276 to end the method 1100. However, if at Block 1270 the orbital device 100 determines that the mission has not been completed based on the mission instructions, the identified mission type, the identified mission parameters, the mission data, frame(s), the frame data, and/or the sensed light data, then the orbital device 100 may continue to Block 1274 to move to Block 1276 illustratively shown in FIG. 12B to continue and repeat at least a portion of the method 1100 as described above.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention.

Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A light filtering system for use in a light sensor carried by an orbital device, the orbital device comprising an orbital computer including a processor, a network device, a power unit, and a datastore, the light filtering system comprising:
a light filter device to be removably carried by the light sensor and positioned between a lens and at least one sub-sensor that are carried by the light sensor, wherein the light filter device is operable to:
receive light passed through the lens to be defined as captured light;
pass the captured light through the light filter device to filter out at least one wavelength of light from the captured light so that the light having the at least one wavelength of light filtered out is defined as a filtered light; and
wherein the at least one wavelength of light filtered out by the light filter device comprises a wavelength of light that is inversely associated with an absorption band of a substance.

2. The light filtering system of claim 1, wherein the light filter device comprises at least one of a dielectric material liquid crystal filter, an acousto-optic tunable filter, a prism, and a diffraction grating system; and wherein the dielectric material includes at least one of a silicon dioxide, a color glass filter, a metal oxide, and a dye.

3. The light filtering system of claim 1, wherein the light filtering device comprises a plurality of light filtering devices; and further comprising a filter selection device configured to select one of the plurality of light filtering devices to which the captured light is received.

4. The light filtering system of claim 3, wherein each of the plurality of light filter devices is operable to filter out different wavelengths of light.

5. The light filtering system of claim 3, wherein the filter selection device is configured to carry the plurality of light filter devices; wherein the filter selection is operable to rotatably move relative to the light sensor to selectively position one of the plurality of light filter devices between the lens and the at least one sub-sensor to receive the captured light.

6. The light filtering system of claim 3, further comprising a filter library configured to be carried by the orbital device and store the plurality light filter devices; wherein the filter selection device is configured to select one of the plurality of light filter devices from the filter library.

7. The light filtering system of claim 3, wherein each of the plurality of light filter devices is positioned adjacent to one another to define a filter device pattern; wherein each light filter device of the filter device pattern is configured to filter out a wavelength of light that differ from adjacent light filter devices of the filter device pattern.

8. The light filtering system of claim 7, wherein the at least one sub-sensor comprises a plurality of sub-sensors; and wherein each light filter device of the filter device pattern is associated with a respective one of the plurality of sub-sensors.

9. The light filtering system of claim 3, wherein the plurality of filter devices includes a first filter device and a second filter device; wherein the first filter device is adapted to filter out a first wavelength of light; wherein the second filter device is adapted to filter out a second wavelength of light; and wherein the filtered light is defined as the captured light being passed through the first filter and the second filter.

10. The light filtering system of claim 1, wherein the at least one wavelength of light filtered out by the light filter device includes wavelengths surrounding at least one of 440 to 520 nanometers (nm), 450 to 700 nm, 530 to 610 nm, 610 to 690 nm, and 740 to 900 nm filter ranges.

11. A light filtering system for use in a light sensor carried by an orbital device, the light filtering system comprising:
a plurality of light filter devices to be removably carried by the light sensor, each of the light filter devices being configured to receive light passed through a lens carried by the light sensor defined as captured light; and
a filter selection device configured to carry each of the plurality of light filter devices and to select one of the plurality of light filtering devices to which the captured light is received;
wherein the captured light is passed through the selected one of the plurality of light filter devices to filter out at least one wavelength of light from the captured light so that the light having the at least one wavelength of light filtered out is defined as a filtered light; and
wherein the at least one wavelength of light filtered out comprises a wavelength of light that is inversely associated with an absorption band of a substance.

12. The light filtering system of claim 11, wherein each of the plurality of light filter devices comprises at least one of a dielectric material liquid crystal filter, an acousto-optic tunable filter, a prism, and a diffraction grating system; and wherein the dielectric material includes at least one of a silicon dioxide, a color glass filter, a metal oxide, and a dye.

13. The light filtering system of claim 11, wherein each of the plurality of light filter devices is operable to filter out different wavelengths of light.

14. The light filtering system of claim 11, wherein the filter selection device is operable to rotatably move relative to the light sensor to selectively position one of the plurality of light filter devices to receive the captured light.

15. The light filtering system of claim 11, further comprising a filter library configured to store the plurality light filter devices; wherein the filter selection device is configured to select one of the plurality of light filter devices from the filter library.

16. The light filtering system of claim 11, wherein the at least one wavelength of light filtered out the plurality of light filter devices includes wavelengths surrounding at least one of 440 to 520 nanometers (nm), 450 to 700 nm, 530 to 610 nm, 610 to 690 nm, and 740 to 900 nm filter ranges.

17. A light filtering system for use in a light sensor carried by an orbital device, the light filtering system comprising:
a plurality of light filter devices that are each configured to receive light passed through a lens carried by the light sensor defined as captured light;
a filter selection device configured to select one of the plurality of light filtering devices which the captured light is received by; and
a filter library configured to store the plurality light filter devices;
wherein the captured light is passed through the selected one of the plurality of light filter devices to filter out at least one wavelength of light from the captured light so that the light having the at least one wavelength of light filtered out is defined as a filtered light;
wherein each of the plurality of light filter devices is operable to filter out different wavelengths of light;
wherein the at least one wavelength of light filtered out comprises a wavelength of light that is inversely associated with an absorption band of a substance;
wherein the filter selection device is operable to rotatably move relative to the light sensor to selectively position one of the plurality of light filter devices to receive the captured light;
wherein the filter selection device is configured to select one of the plurality of light filter devices from the filter library.

18. The light filtering system of claim 17, wherein each of the plurality of light filter devices comprises at least one of a dielectric material liquid crystal filter, an acousto-optic tunable filter, a prism, and a diffraction grating system; and wherein the dielectric material includes at least one of a silicon dioxide, a color glass filter, a metal oxide, and a dye.

19. The light filtering system of claim 17, wherein the at least one wavelength of light filtered out the plurality of light filter devices includes wavelengths surrounding at least one of 440 to 520 nanometers (nm), 450 to 700 nm, 530 to 610 nm, 610 to 690 nm, and 740 to 900 nm filter ranges.

20. The light filtering system of claim 17, wherein the plurality of filter devices are configured so that the captured light is passed through more than one of the plurality of filter devices so that the filtered light is defined as the captured light being passed through more than one of the plurality of filter devices.
